(19) United States
(12) Patent Application Publication
(10) Pub. No.: US 2016/0035230 A1
(43) Pub. Date: Feb. 4, 2016

(54) ASSESSING A USER'S ENGAGEMENT WITH DIGITAL RESOURCES

(71) Applicant: VITAL SOURCE TECHNOLOGIES, INC., Raleigh, NC (US)

(72) Inventor: Bryan Gentry Spaulding, Burlingame, CA (US)

(73) Assignee: VITAL SOURCE TECHNOLOGIES, INC., Raleigh, NC (US)

(21) Appl. No.: 14/273,442

(22) Filed: May 8, 2014

Related U.S. Application Data
(63) Continuation-in-part of application No. 13/949,479, filed on Jul. 24, 2013.
Application No. 13/949,479 is a continuation of application No. 13/914,147, filed on Jun. 10, 2013.
(60) Provisional application No. 61/232,103, filed on Aug. 7, 2009.

(51) Int. Cl. G09B 5/02; G06F 3/0483; G06F 3/0484; H04L 29/08; G09B 7/00

(52) U.S. Cl. CPC G09B 5/02; H04L 67/22; G09B 7/00; G06F 3/0484; G06F 3/0483

(57) ABSTRACT

An engagement index reflects a user's level of engagement with a digital resource. Actions of the user, such as the amount of time spent on a page, the number of pages accessed, the amount of time spent in a session, and the number and type of annotations made may be used as factors in the determination of the engagement index. A graphical user interface includes a display portion that displays information based on one or more engagement indexes. The display portion can include a chart with data points representing average engagement indexes. The graphical user interface can also include an input portion to receive an input identifying one of the data points. In response to an input identifying a data point, the display portion of the graphical user interface is updated to show the engagement indexes used to compute the average engagement index at the identified data point.

### RELATED APPLICATIONS

This application claims priority to U.S. Ser. No. 61/721,592 for System and Method for Assessing a User's Engagement with Digital Resources filed Nov. 2, 2012, and U.S. Ser. No. 13/914,147 for System and Method for Assessing a User's Engagement with Digital Resources filed Jun. 10, 2013, and U.S. Ser. No. 13/949,479 for System and Method for Assessing a User's Engagement with Digital Resources filed Jul. 24, 2013, the entire disclosures of which are incorporated by reference herein.

### BACKGROUND

Educators have used observable behaviors, such as class attendance, class participation, and performance on tests and quizzes, to predict a student's success or failure in a course. Some of these observations may not be made until well into the course, at which point it may be too late to help a student who is not engaged with the course materials and not learning at a pace that will result in successfully completing the course. This scenario may be especially true in higher education where class sizes may be large, classes may be conducted online or via distance learning, and only a few tests or quizzes may be given.

Currently educators do not have a systematic way of assessing student performance until test or quiz results are available. It would be helpful for educators to have a way of assessing the engagement level of students with the course materials in order to identify at-risk students at a point that is early enough to help the students.

### SUMMARY

In general terms, this disclosure is directed to assessing a user's engagement with a digital resource. In one possible configuration and by non-limiting example, an engagement index is determined. Various aspects are described in this disclosure, which include, but are not limited to, the following aspects.

One aspect is a user engagement assessment system for assessing engagement with digital resources, the engagement system comprising: a memory containing interaction data between users and digital resources; first circuitry configured to generate a graphical user interface including engagement index information based on the interaction data, the graphical user interface having an input region and a display region, the display region displaying an engagement index value based on the interaction data; second circuitry configured to receive input information corresponding to a filter selection by an operator in the input region; and third circuitry configured to update the display portion of the graphical user interface to display an updated average engagement index value based on the interaction data that matches the filter selection.

Another aspect is a user engagement assessment system for assessing engagement with digital resources, the engagement system comprising: a memory containing interaction data between users and digital resources; first circuitry configured to generate a graphical user interface having an input region and a display region, the display region displaying a chart including a plurality of data points that represent the average engagement index for users during a particular time period; second circuitry configured to receive input information corresponding to an operator input in the input portion, wherein the input information identifies a data point from the plurality of data points; and third circuitry configured to update the display portion of the graphical user interface based on the input information to display a plurality of the engagement index values used to compute the average engagement index at the identified data point and a plurality of factor values used in computing the plurality of engagement index values.

Another aspect is a method of generating a graphical user interface for use in assessing engagement with digital resources, the method comprising: calculating, with a computing device, a plurality of engagement indexes based on interaction data, wherein the interaction data represents interactions between users and digital resources; generating a graphical user interface including an input portion and a display portion, the display portion displaying a chart including a plurality of data points that represent the average engagement index for users during a particular time period; receiving input information corresponding to an operator input in the input portion, wherein the input information identifies a data point from the plurality of data points; and updating the display portion of the graphical user interface based on the input information to display a plurality of the engagement index values used to compute the average engagement index at the identified data point and a plurality of factor values used in computing the plurality of engagement index values.

Yet another aspect is a method of generating a graphical user interface for use in assessing student engagement with eTextbooks, the method comprising: receiving interaction data comprising data relating to interactions between student and eTextbooks, wherein the interactions represent page views, notes made, highlights made, and bookmarks; dividing the interaction data into a plurality of sessions representing a block of time spent interacting with an eTextbook by a student; calculating, with a computing device, engagement indexes for a plurality of the sessions, wherein the engagement index is a numerical value that represents a particular student's engagement with a particular eTextbook during a particular session, wherein calculating the engagement index comprises: calculating a session duration factor for the particular session based on the length of time the particular student spent interacting with the particular eTextbook during the particular session; calculating a page views factor for the particular session based on the interactions representing page views for the particular session; calculating a notes made factor for the particular session based on the interactions representing notes made for the particular session; calculating a highlights made factor for the particular session based on the interactions representing highlights made for the particular session; calculating a bookmarks factor for the particular session based on the interactions representing bookmarks for the particular session; calculating a score associated with a weighted combination of at least the session duration factor, the page views factor, the notes made factor, the highlights made factor, and the bookmarks factor; and determining the engagement index by adjusting the score to ensure the score is less than an upper bound and greater than a lower bound; generating a graphical user interface comprising: a first display portion that displays an average engagement index for students at a particular institution over a particular time period; a second display portion that displays a chart including a plurality of data points that represent the average engagement index for students at the particular institution during a portion of the particular time period; and an input portion that overlays the second display portion; receiving input information corresponding to an operator input in the input portion, wherein the input information identifies a data point from the plurality of data points; and updating the graphical user interface based on the input information to display a plurality of the engagement index values used to compute the average engagement index at the identified data point and at least one of the session duration factor, the page views factor, the notes made factor, the highlights factor, and the bookmarks factor for at least one of the plurality of engagement index values.

### BRIEF DESCRIPTION OF THE DRAWINGS

FIG. 1 is a flow diagram illustrating an exemplary method for determining an engagement index.

FIG. 2 is a flow diagram further illustrating the method of FIG. 1.

FIG. 3 is a flow diagram further illustrating the method of FIG. 1.

FIG. 4 is a block diagram illustrating an exemplary operating environment.

FIG. 5 is an exemplary user interface illustrating an exemplary engagement index for all students of an institution.

FIG. 6 is an exemplary user interface comparing an engagement index for a student with the average engagement index for students in a class.

FIGS. 7A, 7B, and 7C are exemplary user interfaces comparing engagement factors for a student with the average engagement factors for students in a class.

FIG. 8 is an exemplary user interface showing engagement indexes for students in a class.

FIG. 9 illustrates an exemplary embodiment of a digital resource delivery system.

FIG. 10 illustrates an exemplary architecture of a computing device that can be used to implement aspects of the present disclosure.

FIG. 11 illustrates an exemplary architecture of the program modules and program data of the server of FIG. 9.

FIG. 12 illustrates an exemplary method for operating at least some embodiments of the digital resource delivery platform of FIG. 9.

FIG. 13 is an example format of the digital resources interaction data of FIG. 11.

FIG. 14 illustrates an exemplary method for operating at least some embodiments of the engagement index parameter adjustment engine of FIG. 11.

FIG. 15 illustrates an example user interface generated by at least some embodiments of the user interface engine of FIG. 11.

FIG. 16 illustrates an example user interface generated by at least some embodiments of the user interface engine of FIG. 11.

FIG. 17 illustrates another exemplary embodiment of a digital resource delivery system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of the terms “and” and “or” mean “and/or” unless stated otherwise. The use of “comprise,” “comprises,” “comprising,” “include,” “includes,” and “including” are interchangeable and not intended to be limiting. The terms “such as,” “for example,” and “e.g.” also are not intended to be limiting. For example, the term “including” shall mean “including, but not limited to.”

Aspects of the present disclosure provide a systematic, timely way of monitoring student behaviors that may be used to measure the engagement of a student with a digital resource. In at least some embodiments, the measured level of engagement is used by educators to identify at-risk students, by institutions to assess the level of engagement with a particular digital resource or digital resources in general, or by providers of digital resources to assess the level of engagement with a particular digital resource or a portion of the resource. Although the example embodiments are described in the context of assessing a student's engagement and use of various digital resources, these and other embodiments can be used to track how a variety of different people interact with digital resources for a variety of purposes other than evaluating student performance. Examples include marketing, entertainment, and professional evaluation purposes.

In at least some embodiments, the monitored student behaviors include interactions or factors, such as the amount of time a student spends on a page, the number of pages accessed by a student, the amount of time a student spends accessing the digital resource in a session, and the number and type of annotations made by the student. The system receives data values corresponding to one or more of these factors and validates the data values. The data values are validated to eliminate any extreme or erroneous values and to make the values comparable with one another.

One aspect of the disclosure provides an engagement index that reflects a user's level of engagement with a digital resource. Examples of digital resources include electronic books, including electronic textbooks (“eTextbooks”), electronic course materials, electronic encyclopedias, electronic books other than text books, electronic journals and other magazines, other written materials, electronic quizzes and tests, electronic homework and study problems, audio materials, graphical materials, video materials, computer games, simulators, multimedia content, websites, and other types of content that may be delivered electronically. In at least some embodiments, the digital resources include interactive materials and online resources. In at least some embodiments, the user's interactions with the digital resource are monitored and the data collected is used to calculate the engagement index.

When a user interacts with a digital resource, there are a number of factors that can be measured, such as the amount of time that the user spends on a page, the number of pages accessed by the user, the amount of time the user spends accessing the digital resource, the order in which the user accesses the digital resource (i.e., path analysis), the number and type of annotations made by the user, factors related to printing, downloading, or sharing with other users the digital resource or parts of the digital resource, factors related to the system or device used by the user to access the digital resource, and other factors. Data related to one or more of these, or other, factors are captured and analyzed to determine the engagement index.

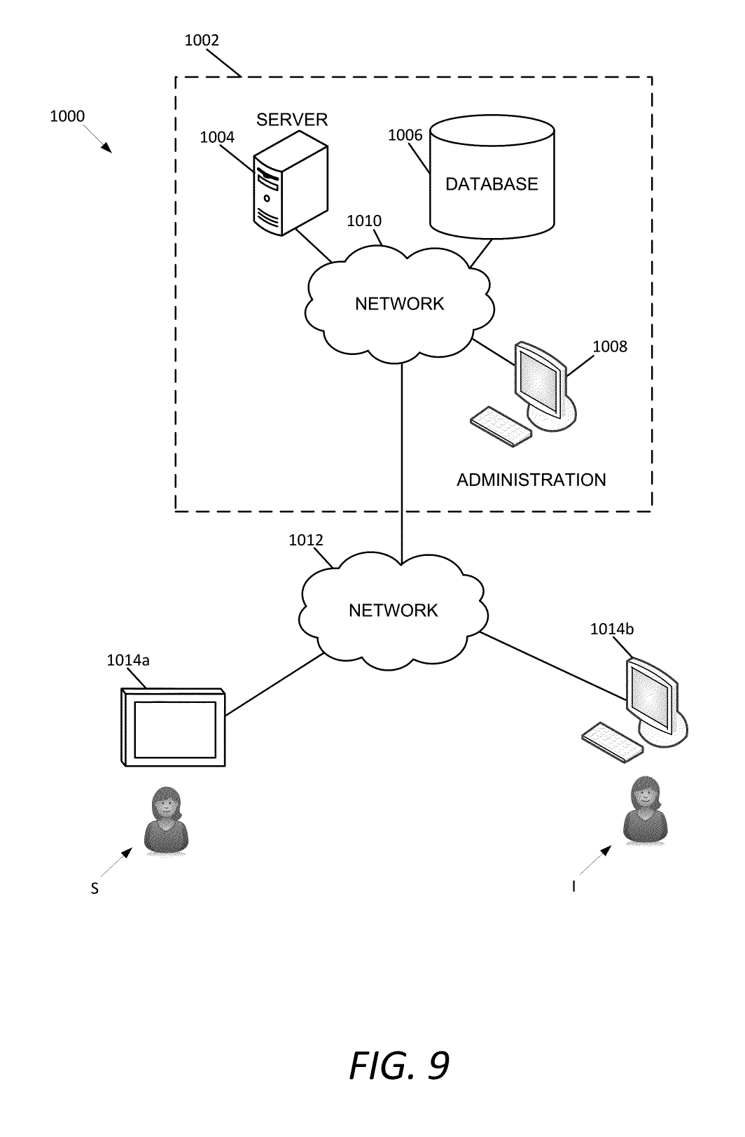

FIG. 9 illustrates an exemplary embodiment of a digital resource delivery system 1000. Students and institutional users interact with the digital resource delivery system 1000 to access digital resources and evaluate engagement with those digital resources. The system 1000 includes a platform 1002 for analyzing engagement with digital resources, a network 1012, and user computing devices 1014a and 1014b (collectively, user computing devices 1014).

For purposes of illustration, the engagement index will be described in the context of a student accessing an eTextbook through the platform 1002. In some embodiments, the platform 1002 provides the student with access to the eTextbook and captures the data needed to calculate the engagement index. In this exemplary embodiment, the user computing device 1014a is associated with a student and the user computing device 1014b is associated with an institutional user, such as an instructor or other educator. However, in at least some other embodiments, the engagement index is used in the context of digital resources other than eTextbooks.

At least some embodiments of the platform 1002 include a server 1004, a database 1006, and an administration computing device 1008 that communicate across a network 1010. The platform 1002 operates to provide access to digital resources through the network 1012 when requested by one of the user computing devices 1014. The platform 1002 also operates to capture data relating to the engagement of users with digital resources. The platform 1002 is located at the same location (such as in the same room, building, or facility) as one or more of the user computing devices 1014. Alternatively, the platform 1002 is located remote from the user computing devices 1014, such as in a different building, city, state, country, or continent.

In at least some embodiments, the server 1004 controls access to information and digital resources stored in the platform 1002. The server 1004 is a computing device that includes a database software application, such as the SQL SERVER® database software distributed by MICROSOFT® Corporation. In at least some other embodiments, the server 1004 is a Web server or a file server. When a request for a digital resource is received by the server 1004, the server 1004 retrieves the digital resource from the database 1006 and sends it across the network 1012 to one of the user computing devices 1014 that requested it. In at least some embodiments, the server 1004 also stores information about requests for digital resources and engagement with digital resources in the database 1006. In some embodiments, the server 1004 comprises a plurality of computing devices that are located in one or more physical locations. For example, the server 1004 can be a single server or a bank of servers.

The database 1006 is a data storage device configured to store digital resources and a variety of information related to those digital resources. Examples of the database 1006 include a hard disk drive, a collection of hard disk drives, digital memory (such as random access memory), a redundant array of independent disks (RAID), optical or solid state storage devices, or other data storage devices. The digital resources and information related to those digital resources can be distributed across multiple local or remote data storage devices. The database 1006 stores data in an organized manner, such as in a hierarchical or relational database structure, or in lists and other data structures such as tables. The database 1006 is located on the server 1004. The database 1006 can be stored on a single data storage device or distributed across two or more data storage devices that are located in one or more physical locations.

The administration computing device 1008 is a computing device configured for administration of the platform 1002. The administration computing device 1008 can be configured to create users and institutions in the database 1006 and to add digital resources to the database 1006.

The network 1010 communicates digital data between the server 1004, the database 1006, and the administration computing device 1008. The network 1010 can be a local area network or a wide area network, such as the Internet. The server 1004, the database 1006, and the administration computing device 1008 can be in the same or remote locations.

Similarly, the network 1012 communicates digital data between one or more computing devices, such as between the platform 1002 and the computing devices 1014. The network 1012 can be a local area network or a wide area network, such as the

Internet. In at least some embodiments, the network 1010 and the network 1012 are the same (i.e., a single) network.

In at least some embodiments, one or both of the network 1010 and the network 1012 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of optical signals or radio frequency (RF) signals. A wireless communication system typically includes an optical or RF transmitter for transmitting optical or radio frequency signals, and an optical or RF receiver for receiving optical or radio frequency signals. Examples of wireless communication systems include Wi-Fi communication devices (such as utilizing wireless routers or wireless access points), cellular communication devices (such as utilizing one or more cellular base stations), and other wireless communication devices.

Although the platform 1002 is illustrated as being separated from the computing devices 1014 by the network 1010, part or all of the platform 1002 is on a local data storage device of one of the computing devices 1014 in at least some embodiments.

The computing device 1014a is a computing device used by the student S to access the platform 1002. The computing device 1014b is a computing device used by the institutional user Ito access the platform 1002. There can be multiple students using multiple user computing devices and multiple institutional users using multiple user computing devices.

In at least some embodiments, the computing devices 1014 are desktop computer computing devices. Alternatively, the computing devices 1014 can be laptop computers, tablet computers (e.g., the iPad® device available from Apple, Inc., or other tablet computers running an operating system like a Microsoft Windows® operating system from Microsoft Corporation of Redmond, Wash., or an Android® operating system from Google Inc. of Mountain View, Calif.), smartphones, e-book readers, or other stationary or mobile computing devices configured to process digital instructions. In at least some embodiments, the computing devices 1014 include a touch sensitive display for receiving input from a user either by touching with a finger or using a stylus. More or fewer of the computing devices 1014 are included in at least some other embodiments and are located in one or more facilities, buildings, or geographic locations.

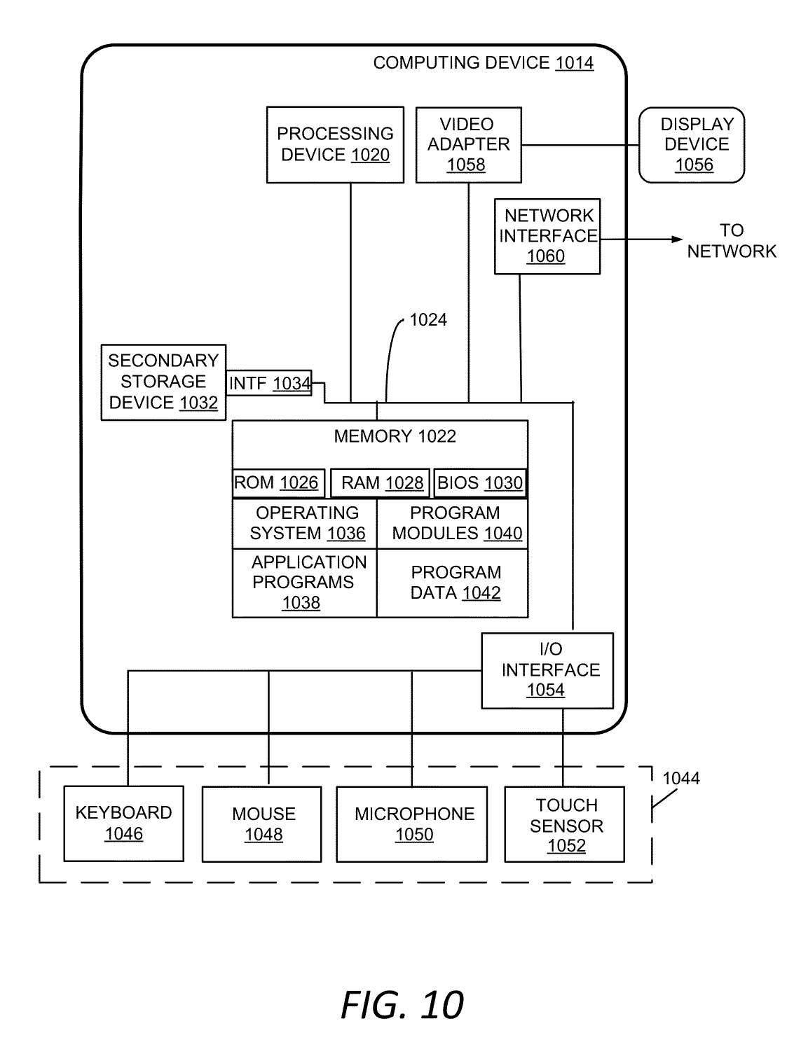

FIG. 10 illustrates an exemplary architecture of a computing device that can be used to implement aspects of the present disclosure, including the server 1004, the administration computing device 1008, or the computing devices 1014, and will be referred to herein as the computing device 1014. One or more computing devices, such as the type illustrated in FIG. 10, are used to execute the operating system, application programs, and software modules (including the software engines) described herein.

The computing device 1014 includes, in some embodiments, at least one processing device 1020, such as a central processing unit (CPU) such as a multipurpose microprocessor or other programmable electrical circuit. A variety of processing devices are available from a variety of manufacturers, for example, Intel or Advanced Micro Devices. In this example, the computing device 1014 also includes a system memory 1022, and a system bus 1024 that couples various system components including the system memory 1022 to the processing device 1020. The system bus 1024 is one of any number of types of bus structures including a memory bus or memory controller, a peripheral bus, and a local bus using any of a variety of bus architectures.

The system memory 1022 includes read only memory 1026 and random access memory 1028. A basic input/output system 1030 containing the basic routines that act to transfer information within computing device 1014, such as during start up, is typically stored in the read only memory 1026.

The computing device 1014 also includes a secondary storage device 1032 in some embodiments, such as a hard disk drive, for storing digital data. The secondary storage device 1032 is connected to the system bus 1024 by a secondary storage interface 1034. The secondary storage devices and their associated computer readable media provide nonvolatile storage of computer readable instructions (including application programs and program modules), data structures, and other data for the computing device 1014.

Although the exemplary environment described herein employs a hard disk drive as a secondary storage device, other types of computer readable storage media are used in other embodiments. Examples of these other types of computer readable storage media include magnetic cassettes, flash memory or other solid state memory technology, digital video disks, Bernoulli cartridges, compact disc read only memories, digital versatile disk read only memories, random access memories, or read only memories. Some embodiments include non-transitory media.

A number of program modules can be stored in secondary storage device 1032 or memory 1022, including an operating system 1036, one or more application programs 1038, other program modules 1040, and program data 1042. The database 1006 may be stored at any location in the memory 1022, such as the program data 1042, or at the secondary storage device 1032.

The computing device 1014 includes input devices 1044 to enable the user to provide inputs to the computing device 1014. Examples of input devices 1044 include a keyboard 1046, pointer input device 1048, microphone 1050, and touch sensor 1052. A touch-sensitive display device is an example of a touch sensor. Other embodiments include other input devices 1044. The input devices are often connected to the processing device 1020 through an input/output interface 1054 that is coupled to the system bus 1024. These input devices 1044 can be connected by any number of input/output interfaces, such as a parallel port, serial port, game port, or a universal serial bus. Wireless communication between input devices 1044 and interface 1054 is possible as well, and includes infrared, BLUETOOTH® wireless technology, 802.11a/b/g/n, cellular or other radio frequency communication systems in some possible embodiments.

In this example embodiment, a touch sensitive display device 1056 is also connected to the system bus 1024 via an interface, such as a video adapter 1058. The touch sensitive display device 1056 includes a sensor for receiving input from a user when the user touches the display or, in some embodiments, or gets close to touching the display. Such sensors can be capacitive sensors, pressure sensors, optical sensors, or other touch sensors. The sensors not only detect contact with the display, but also the location of the contact and movement of the contact over time. For example, a user can move a finger or stylus across the screen or near the screen to provide written inputs. The written inputs are evaluated and, in some embodiments, converted into text inputs.

In addition to the touch sensitive display device 1056, the computing device 1014 can include various other peripheral devices (not shown), such as speakers or a printer.

When used in a local area networking environment or a wide area networking environment (such as the Internet), the computing device 1014 is typically connected to the network through a network interface, such as a wireless network interface 1060. Other possible embodiments use other communication devices. For example, some embodiments of the computing device 1014 include an Ethernet network interface, or a modem for communicating across the network.

The computing device 1014 typically includes at least some form of computer-readable media. Computer readable media includes any available media that can be accessed by the computing device 1014. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1014.

Computer readable communication media typically embodies computer readable instructions, data structures, program modules or other data in a data signal. A data signal can be a modulated signal such as a carrier wave or other transport mechanism that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

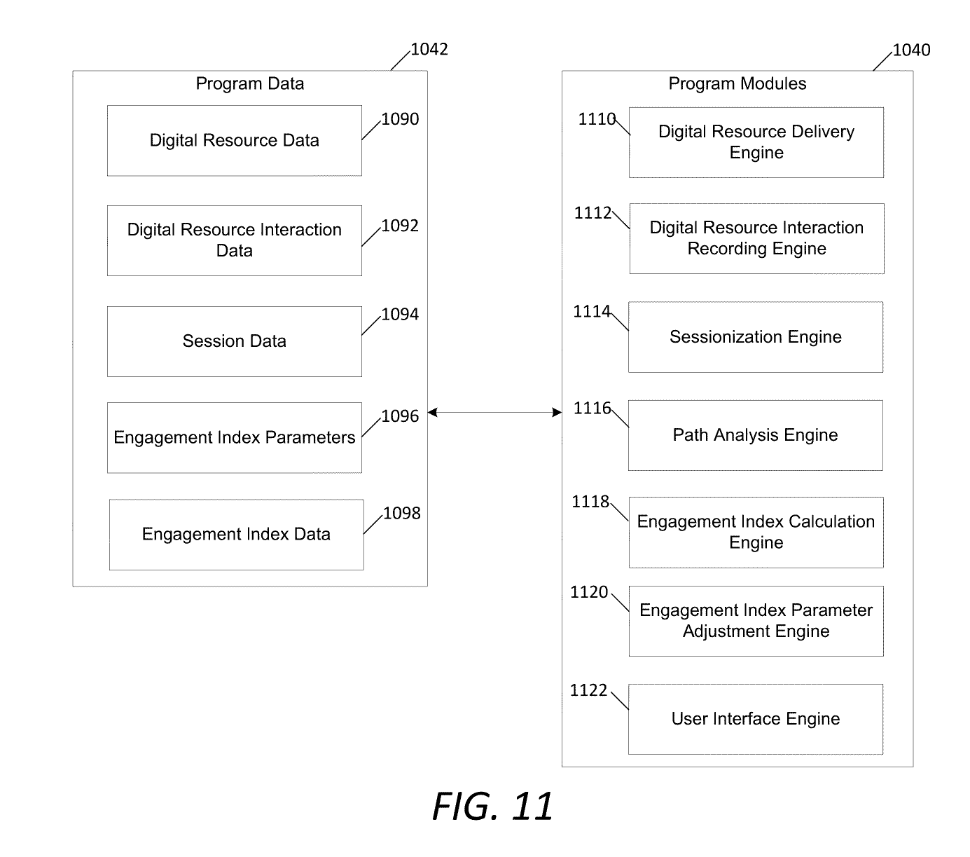

FIG. 11 illustrates an exemplary architecture of the program modules 1040 and program data 1042 of the server 1004 or the user computing devices 1014. The program modules 1040 include a plurality of modules that, when executed by the processing device 1020 (shown in FIG. 10), perform one or more operations of the server 1004. The modules include a digital resource delivery engine 1110, a digital resource interaction recording engine 1112, a sessionization engine 1114, a path analysis engine 1116, an engagement index calculation engine 1118, an engagement index parameter adjustment engine 1120, and a user interface engine 1122. The program modules 1040 can include more, fewer, or different modules than those shown in FIG. 11.

The program data 1042 is stored in a data storage device, such as the memory 1022 or the secondary storage device 1032 (shown in FIG. 10). The program data 1042 includes digital resource data 1090, digital resource interaction data 1092, session data 1094, engagement index parameters 1096, and engagement index data 1098. The program data 1042 can include more, fewer, or different types of data than the data shown in FIG. 11.

The data stored in program data 1042 can be represented in one or more files having any format usable by a computer. Examples include text files formatted according to a markup language and having data items and tags to instruct computer programs and processes how to use and present the data item. Examples of such formats include html, xml, and xhtml, although other formats for text files can be used. Additionally, the data can be represented using formats other than those conforming to a markup language. In alternative embodiments, some or all of the program data 1042 can be stored on one of the computing devices 1014.

The digital resource delivery engine 1110 operates to deliver a digital resource or a portion of a digital resource from the digital resource data 1090 to at least one of the computing devices 1014. The digital resource delivery engine 1110 can be a webserver that provides the digital resource (e.g., an eTextbook) on a webpage. In these embodiments, the student S accesses the contents of the eTextbook through a web browser on a laptop, desktop, smartphone, tablet, mobile device, e-book reader, or other type of reading device that communicates with the digital resource delivery engine 1110. Alternatively, the digital resource delivery engine 1110 delivers the digital resource to the student computing device 1014a, where it is locally stored.

The digital resource interaction recording engine 1112 operates to record information related to a user's (e.g., the student S) interactions with a digital resource. The digital resource interaction recording engine 1112 can include web server logging capabilities. The digital resource interaction recording engine 1112 stores data about a user's interaction with the digital resource. Examples of such data include a time stamp when a session with a digital resource starts, as well as time stamps when each page of the digital resource is requested, when any annotation is made, and when the session ends.

In at least some possible embodiments, a session starts when a student S first requests a digital resource. Upon a request for the digital resource, the digital resource interaction recording engine 1112 sends a cookie that represents a session to the student's web browser. The student's web browser stores the cookie after receiving it and includes the cookie in all future requests for the digital resource. The digital resource interaction recording engine 1112 then uses the cookie to associate the request with a session. The cookie stores information that identifies the student and the session. The cookie also may store a value that corresponds to a record in a session table in a database. Alternative embodiments may use mechanisms and methods other than cookies to associate a web request with a session or a user.

The digital resource interaction recording engine 1112 operates to collect and store the digital resource interaction data 1092 representing the student's S or other user's interaction with the digital resource. Examples of such data includes the number of pages accessed, time spent on each page, and annotation details. The annotation details recorded can include the number of words or lines highlighted, the content of the words highlighted, the number of highlighting colors used, the number of notes made, the length of the notes made, and the content of the notes made. The digital resource interaction data 1092 also can include data such as whether the student S answered problem sets, how the student S answered problem sets, or whether the student S interacted with other embedded content elements such as embedded graphics, video, and audio.

In at least one alternative to accessing the digital resource through a browser, the student accesses the eTextbook through a stand-alone digital resource viewer on one of the computing devices 1014. The student S receives at least a portion of the digital resource and stores it locally on the computing device 1014a. In this manner, the student S is able to access the digital resource even when the computing device 1014a is unable to communicate with the platform 1002. The digital resource viewer stores the digital resource interaction data 1092 related to the student's S interactions with the digital resource locally on the computing device 1014a. The digital resource interaction data 1092 is then transmitted to the digital resource interaction recording engine 1112 at a later time when the computing device 1014a is able to communicate with the platform 1002. If the computing device 1014a locally stores the digital resource interaction data 1092 and has access to the platform 1002, the digital resource interaction data 1092 can be transmitted to the digital resource interaction recording engine 1112 in real time, on regular intervals, upon completion of the session, upon manually actuating a synchronization command, and the like.

The sessionization engine 1114 operates to separate the digital resource interaction data 1092 into sessions associated with the session data 1094. A session represents a continuous block of time spent interacting with the digital resource by the user, and the session data 1094 is the digital resource interaction data 1092 that was generated during the session. The sessionization engine can use different factors for separating the digital resource interaction data 1092 into different sessions. For example, the sessionization engine 1114 can divide the digital resource interaction data 1092 into sessions based on the duration of time that passes between recorded interaction events. If the duration of the time that passes between recorded events is greater than a predetermined threshold, the sessionization engine 1114 determines that a first session has ended and a new session has begun. In at least some other embodiments, the predetermined threshold can vary based on one or more factors such as the complexity of the material in the digital resource. In this manner, the sessionization engine 1114 excludes time periods that exceed the predetermined threshold (e.g., breaks) from being included in the sessions. As an alternative, the sessionization engine 1114 identifies sessions based on when a student logs-in and logs-out of a digital resource. Other embodiments of the sessionization engine 1114 are possible as well.

The path analysis engine 1116 operates to analyze the order in which the user interacts with the digital resource. The path analysis engine 1116 analyzes one or both of the sequence and cadence of page views of an eTextbook. The data generated by the path analysis engine is collected by the digital resource interaction recording engine 1112 as digital resource interaction data 1092. In at least some embodiments, the engagement index calculation engine 1118 calculates a different engagement index when a user hops back and forth between pages non-sequentially than when a user moves through the pages sequentially. The engagement index calculation engine 1118 also can calculate the engagement index, EI, using other factors generated by the path analysis such as the cadence the user moves through pages of a digital resource, whether and how frequently the user refers to certain passages or material with in the digital resource such as an appendix, and whether the user follows links embedded within the digital resource.

The engagement index calculation engine 1118 operates to calculate the engagement index based on one or more of the digital resource data 1090, digital resource interaction data 1092, and session data 1094. The engagement index calculation engine 1118 stores the engagement index in the engagement index data 1098 so that it can be accessed later. Once the digital resource interaction data 1092 is collected, there may be some initial processing of the data. The initial processing may depend upon the type of data received. The initial processing may automatically detect and exclude invalid data. For example, a student's attempt to access a page that does not exist would not be included in the page count.

The specific data collected and the way the values used in the engagement index are determined may vary between different embodiments. For example, the engagement index can be based on the time spent on a page and is determined by considering the total number of pages viewed in a session and the session length. The time spent on a page can be determined by spreading the time evenly across the number of pages accessed during the session or by spreading the time based on a weighting that considers the complexity or level of detail of the information presented on each page. Alternatively, the time spent on a page is determined using time stamps that capture the time when each page is loaded so that the actual time spent on each page can be used to determine the engagement index.

The engagement index parameter adjustment engine 1120 operates to adjust the engagement index parameters 1096. There are several different ways that the engagement index parameter adjustment engine 1120 can adjust the engagement index parameters 1096. For example, the engagement index parameter adjustment engine 1120 can receive new parameters from a user via the administration computing device 1008. Alternatively, the engagement index parameter adjustment engine 1120 can automatically adjust the engagement index parameters 1096 without user interaction. For example, the engagement index parameter adjustment engine 1120 can receive assessment data that relates to the performance of one or more students, perform regression analysis to quantify the degree of correlation between the engagement index and the assessment data, and calculate new engagement index parameters 1096 that increase the degree of correlation between the engagement index and the assessment data.

The engagement index parameter adjustment engine 1120 operates to adjust the engagement index parameters 1096 at regular intervals (e.g., weekly, monthly, or quarterly). Alternatively, the engagement index parameter adjustment engine 1120 operates to adjust the engagement index parameters on demand or upon the occurrence of a specific event (e.g., receiving new assessment data).

The user interface engine 1122 operates to generate and present a user interface, such as a graphical user interface, to a user. The user interface engine 1122 transmits the user interface to one of the computing devices 1014 through the network 1012.

In at least some embodiments, the program modules 1040 illustrated in FIG. 11 are included in the server 1004. Alternatively, some or all of the program modules 1040 are included on the computing devices 1014. For example, the digital resource interaction recording engine 1112 can operate on the student computing device 1014a. This arrangement can be particularly useful when the student has downloaded a digital resource and is using it while offline. Similarly, the sessionization engine 1114 can operate on the student computing device 1014a to identify sessions while a digital resource is accessed offline. As an additional example, the user interface engine 1122 can operate on the institutional user computing device 1014b to provide a user interface to view the engagement indexes from an application.

In at least some embodiments, the engagement index is calculated at the session level. A session may be a single period during which the student is engaged with the digital resource. In the eTextbook example, the session may include a 2-hour time period during which the student views pages within an eTextbook and makes annotations. The annotations can include highlights, bookmarks, notes, and other markings The notes may be associated with a particular page or with a particular anchor point on a particular page. In at least some embodiments, the engagement index is based on one or more of the following factors: the number of pages viewed, the length of a session, and the annotations made. The engagement index can be based on additional or alternative factors as well. An example of such alternative factors includes the path analysis (i.e., the order of the pages viewed). Another example of alternative factors includes the system or device used by the user to access the eTextbook, such as the device type, operating system and version, and/or application features utilized. Yet another example factor is whether the user accessed other cross-reference materials such as an appendix or dictionary. When a factor is related to viewing, the factor may also include printing, downloading, or sharing with other users, and when a factor is related to making an annotation, the factor may also include viewing, printing, editing, sharing, or deleting an annotation.

In at least some embodiments, multiple engagement indexes are calculated using different sets of input data. The multiple engagement indexes then can be compared to each other. The comparison is typically between engagement indexes that are calculated from sets of input data having at least one common dimension. The common dimension is a characteristic of the digital resource interaction data 1092 that is common between different sets of data and is used in calculating the multiple engagement indexes. For example, multiple engagement indexes can be computed using a common time dimension, which is a period over which the digital resource engagement data 1092 was collected. For example, the multiple engagement indexes can be calculated from digital resource interaction data 1092 collected during the same calendar week. A first engagement index can be calculated based on the digital resource interaction data 1092 associated with a first student during a particular week, and a second engagement index can be calculated based on the digital resource interaction data 1092 associated with a second student during that same week. Alternatively, the time dimension can represent other periods of time such as a particular calendar month, an academic term, or another period of time. Other examples of dimensions that two or more engagement indexes might have in common and that might be used as the basis for a comparison include a user dimension, a context dimension, a geographic dimension, and a content dimension. A user dimension may compare multiple engagement scores for the same student, faculty member, group of students, or group of faculty members. A context dimension may compare multiple engagement scores for the same course or institution. A geographic dimension may compare multiple engagement scores for the same city, county, state, region, country, or other geographic area. A content dimension may compare multiple engagement scores for the same page, section, ISBN, discipline, publisher, or other type of content.

The engagement index is a numeric value calculated by summing multiple individually weighted input factors. The weighting of factors used to calculate the engagement index can be varied based on a variety of factors. For example, when it is determined that session length is a better predictor than annotations for identifying at-risk students, the session length is given more weight when calculating student engagement or risk of poor performance than the number of annotations.

One exemplary form of an engagement index (EI) is shown below:

EI=ƒ₀(a*ƒ₁(first factor value)+b*ƒ₂(second factor value)+c*ƒ₃(third factor value)+ . . . +z*ƒₙ(last factor value)) (1)

Where

a, b, c, . . . z represent weighting coefficients

ƒ_{1, 2, . . . , n} represent factor validation functions

ƒ₀ represents an index validation function

Additionally, the factor value corresponds to the digital resource interaction data 1092. The factor value can be a data value collected by the digital resource interaction recording engine 1112. Alternatively, the factor value can be derived from the data value collected by the digital resource interaction recording engine 1112.

In the context of a student accessing an eTextbook, equation (1) may be implemented as shown below:

EI=ƒ₀(a*ƒ₁(session page views)+b*71 ₂(session duration)+c*ƒ₃(session notes made)+d*ƒ₄(highlights made)+e*ƒ₅(bookmarks made)) (2)

The weighting coefficients (a, b, c, . . . z) determine the relative contribution of each factor to the engagement index and are independent of each other. The weighting coefficients may differ based on a variety of different factors such as the subject matter of the digital resource, the specific course, the specific institution providing the course, the type of institution (e.g., private or public) providing the course, the type of course (e.g., traditional, online, distance, or blended), the instructor, or any other relevant dimension. In at least some embodiments, the weighting coefficients have the following values: a=35%, b=35%, c=10%, d=10%, e=10%. In these embodiments, a low engagement index indicates a lack of engagement with the course materials, while a high engagement index indicates significant engagement with the course materials.

The index validation function (ƒ₀) adjusts the weighted sum of the validated factor values to ensure that the engagement index, EI, is within a predetermined range. For example, the index validation functions (ƒ₀) can ensure that the engagement index is between a lower bound (e.g., 20) and an upper bound (e.g., 100). People are typically familiar with 100 point scales, which makes it easier for a user to evaluate the engagement index than if a different scale was used or if no scale was used at all. The lower bound is chosen to soften the psychological blow of a low engagement index, EI. The index validation functions (ƒ₀) can adjust the weighted sum by adding the lower bound value to the weighted sum of the validated factor values, and if the adjusted sum exceeds the upper bound value using the upper bound value as the engagement index, EI. Alternatively, the index validation functions (ƒ₀) can linearly or nonlinearly map the weighted sum of the validated function values to a value that is between the lower bound and the upper bound. As another alternative, the numeric value of the engagement index, EI, can be converted to a letter value or other non-numeric value.

The factor validation functions (ƒ_{1, 2, . . . n}) operate to adjust the factor values so that they are comparable to one another and do not include any extreme values. The factor validation functions (ƒ_{1, 2, . . . n}) also can operate to adjust the factor values to ensure that the values accurately reflect engagement with the digital resource or to limit certain factor values between a predetermined upper value and a predetermined lower value.

A page count factor can be validated by a factor validation function (ƒ_{1, 2, . . . n}) that ensures that the validated value reflects the number of pages in which there was meaningful interaction between the user and the page. For example, if a user reads or skims 3 pages, but “flips” through 10 additional pages to navigate to those 3 pages, then the validated value will be closer to 3 than to 13. The time spent on a page is compared to a threshold time and the result of the comparison is used to determine whether to include the page in the validated page count value. In this manner, a page that is flipped to get to the next page is not included in the validated page count value.

A length of session value can be validated by a factor validation function (ƒ_{1, 2, . . . n}) that operates to attenuate session lengths that exceed a threshold. For example, the threshold can be selected based on different factors such as a length of time that a user would realistically interact with a digital resource, the age of the user, the difficulty of the material in the digital resource, or the type of digital resource. In this manner, the factor validation function (ƒ_{1, 2, . . . n}) excludes from the engagement index the digital equivalent of a user leaving a book open for hours without reading it.

Another example factor validation function (ƒ_{1, 2, . . . n}) compares the number of words or lines highlighted to a threshold to determine whether to count the highlight. A factor validation function can be included that converts the number of words in a note to a number of characters and compares the number of characters to a threshold to determine whether to count the note.

The factor validation functions (ƒ_{1, 2, . . . n}) are used to ensure that each factor value is consistent in scale with other factor values and fit within the range of the engagement index. For example, factor validation functions (ƒ_{1, 2, . . . n}) can be set to scale the factor values so that a factor value that indicates high engagement is approximately equal for each of the factors. For example, factor validation functions (ƒ_{1, 2, . . . n}) can be set to scale the factor values to better fit within the range of the engagement index. If a 100 point scale is used for the engagement index, the factor validation functions (ƒ_{1, 2, . . . n}) and the weighting coefficients (a, b, c, . . . z) are selected so the sum generally falls within a 100 point scale. In other examples, the factor validation functions (ƒ_{1, 2, . . . n}) are set to adjust, transform, or convert a factor value to one that more accurately reflects engagement.

In at least some embodiments, the parameters and functions used to calculate the engagement index, EI, can be adjusted over time. Examples of parameters that can be adjusted include the factors, validation functions, and weighting values for the factors. Identifying at-risk students is an example scenario in which a user might adjust the parameters and functions used to calculate the engagement index, EI. In this scenario, the way the index is calculated can be adjusted based on the correlation of the engagement indexes to the successful completion of the course for students in a previous course. For example, if the weighting coefficients for the previous course were set so that the factor related to number of pages viewed was weighted more than the factor related to highlights made, but highlights made was found to be a better predictor for successfully completing the course, then for subsequent courses the weighting coefficients would be adjusted to increase the weight given highlighting and decrease the weight given to the page count.

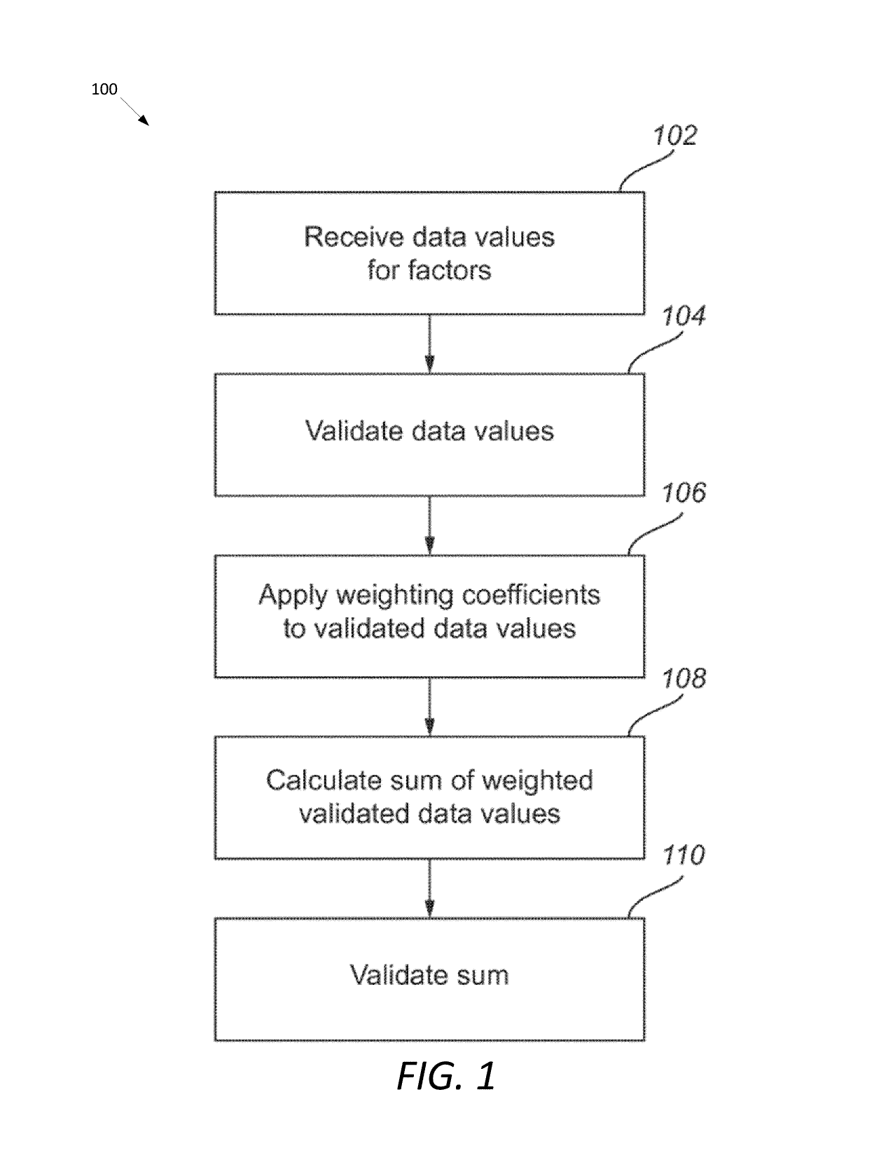

FIG. 1 illustrates an exemplary method 100 for operating at least some embodiments of the engagement index calculation engine 1118 to determine an engagement index. In this example, the method 100 includes operations 102, 104, 106, 108, and 110. In some embodiments, the method includes operations that are performed by a processor (such as the processing device 1020, shown in FIG. 10).

The method begins at operation 102 where the system receives the data values for the factors collected by the digital resource interaction recording engine 1112 and used in calculating the engagement index, EI. At operation 104, the system applies a factor validation function to each of the data values. Once the data values are validated, the system applies a weighting coefficient (a, b, c, . . . z) to each of the values at operation 106. At operation 108, the system adds the weighted, validated data values together and at operation 110, the system validates the sum using the index validation function (ƒ₀). In at least some other embodiments, the engagement index is determined using equation(s) different than Equations (1) and (2) or different methods.

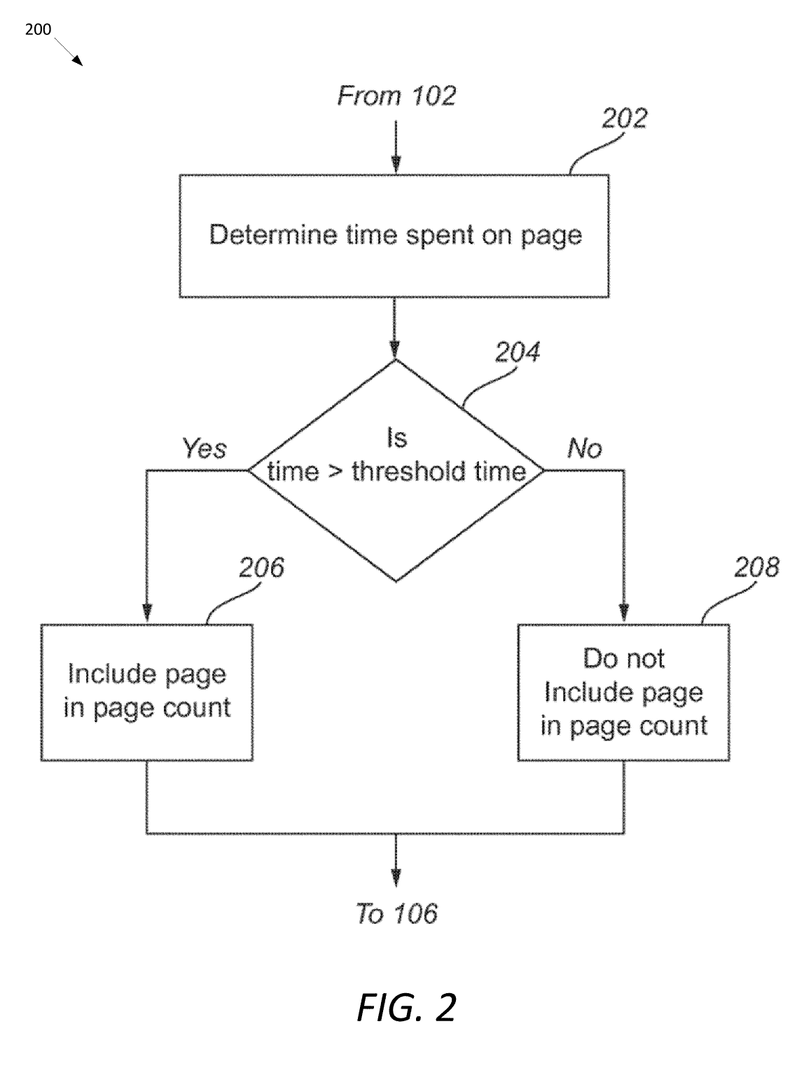

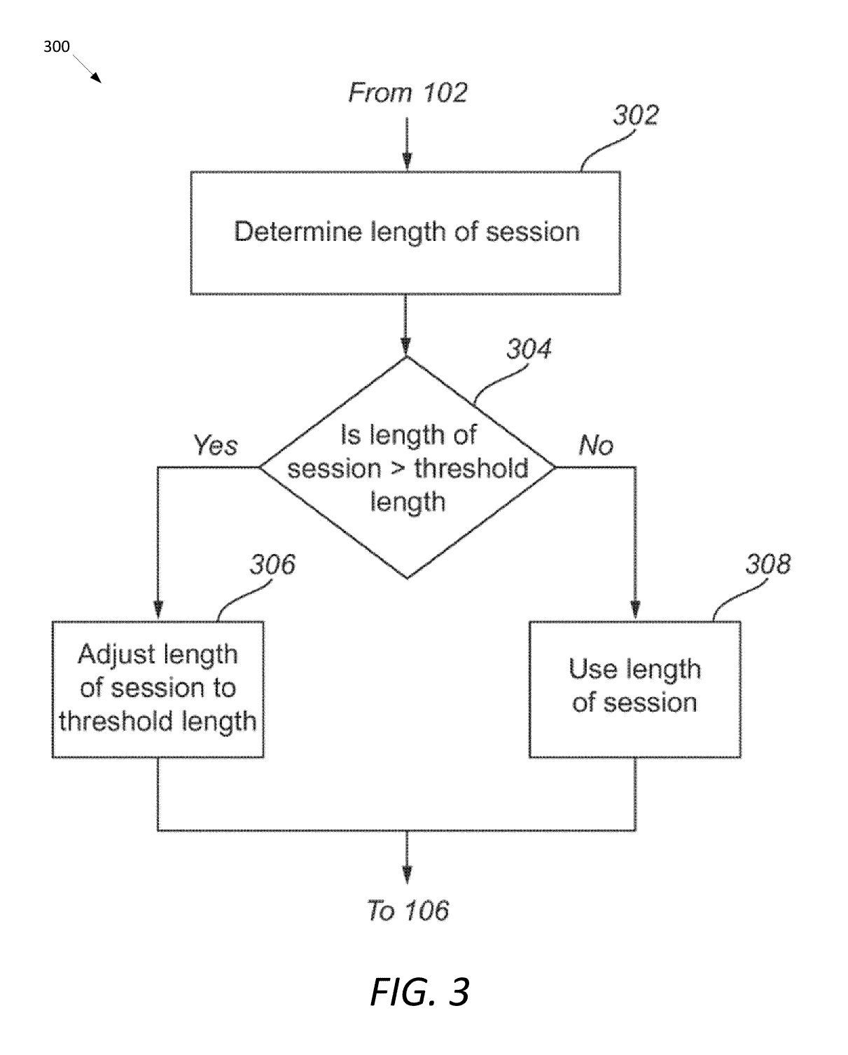

FIGS. 2 and 3 each illustrate a method of operating at least some embodiments of the engagement index calculation engine 1118 to perform an exemplary factor validation function also referred to herein as a validation method, as shown at operation 104 in FIG. 1.

FIG. 2 illustrates a method 200 for operating at least some embodiments of the engagement index calculation engine 1118 to perform an exemplary factor validation function related to page count. In this example, the method 200 includes operations 202, 204, 206, and 208. In some embodiments, the method includes operations that are performed by a processor (such as the processing device 1020, shown in FIG. 10).

The method 200 proceeds from operation 102 in FIGS. 1 to 202 in FIG. 2 where the system determines the time spent on a page. At operation 204, the system compares the time spent on the page to a threshold time. If the time spent on the page is greater than the threshold time, then the system follows the Yes branch to operation 206 and includes the page in the page count. If the time spent on the page is not greater than the threshold time, then the system follows the No branch to operation 208 and does not include the page in the page count. The system proceeds to operation 106 in FIG. 1 from either operation 206 or operation 208. In at least some other embodiments, the page count validation function operates differently.

FIG. 3 illustrates a method 300 for operating at least some embodiments of the engagement index calculation engine 1118 to perform an exemplary factor validation function related to session length. In this example, the method 300 includes operations 302, 304, 306, and 308. In some embodiments, the method includes operations that are performed by a processor (such as the processing device 1020, shown in FIG. 10).

The method 300 proceeds from operation 102 in FIG. 1 to operation 302 of FIG. 3 where the system determines the length of the session. At operation 304, the system compares the length of the session to a threshold length. In at least some embodiments, the threshold length is a fixed value based on the time a typical person can focus on one thing without taking a break and is stored in the engagement index parameters 1096. The threshold length can be set by the administrator at the administration computing device 1008 or by the teacher at the computing device 1014b. If the session length is greater than the threshold length, then the system follows the Yes branch to operation 306 and the system adjusts the session length to be equal to the threshold length. If the session length is not greater than the threshold length, then the system follows the No branch to operation 308 and uses the session length to determine the engagement index. The system proceeds to 106 in FIG. 1 from either 306 or 308. In at least some other embodiments, the session length validation function operates differently.

FIGS. 2 and 3 illustrate two exemplary embodiments for determining two factor validation functions (ƒ_{1, 2, . . . n}). Exemplary embodiments can include operations for determining just one of the factor validation functions illustrated in FIGS. 2 and 3 or determining both factor validation functions. Yet other embodiments can include operations for determining factor validation functions in addition to or in place of the factor validation functions illustrated in FIGS. 2 and 3.

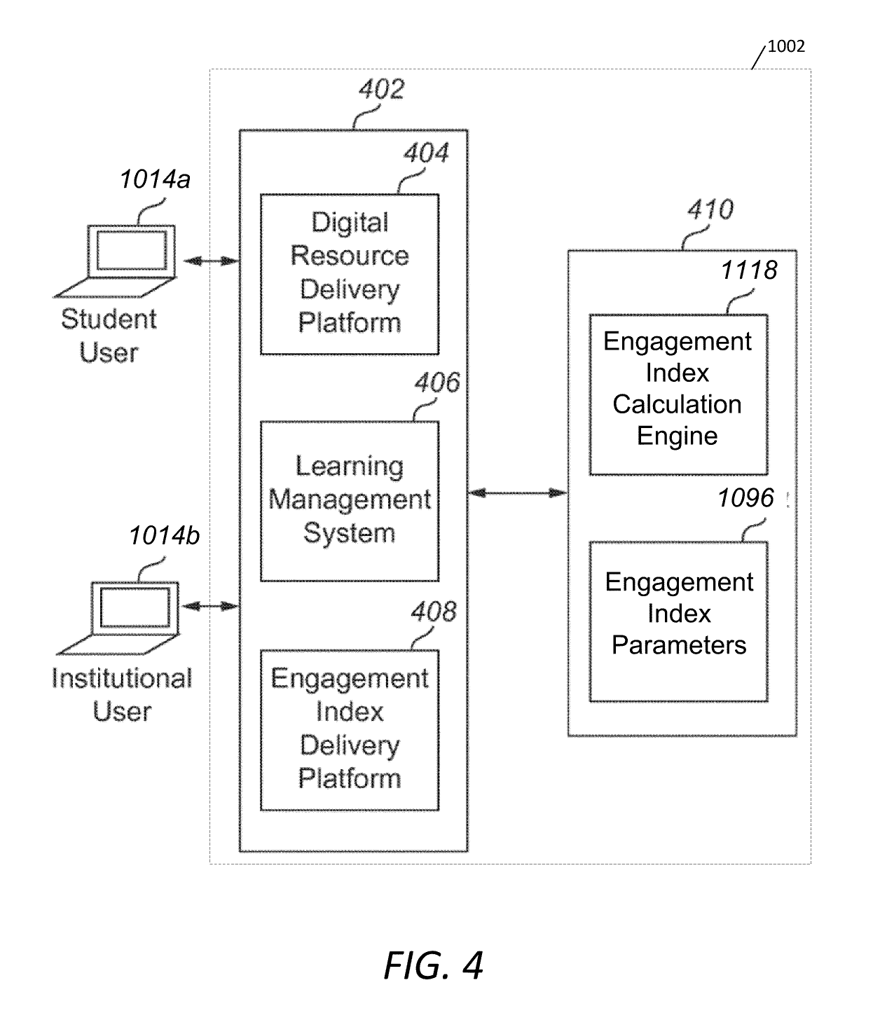

FIG. 4 illustrates an exemplary operating environment for the example of a student accessing an eTextbook. FIG. 4 illustrates an interface system 402 that includes a digital resource delivery platform 404, a learning management system (LMS) 406, and an engagement index delivery platform 408. The digital resource delivery platform 404 operates to provide a student computing device 1014a with access to an eTextbook or other digital resources. The digital resource is stored on the interface system 402, in the database 1006 (shown in FIG. 9), or on another system (not shown) that is accessed by the interface system 402. In at least some embodiments, one or both of the digital resource delivery platform 404 and the engagement index delivery platform 408 are part of the LMS 406. Alternatively, the digital resource delivery platform 404 and the engagement index delivery platform 408 are separate from the LMS 406. The LMS 406 may integrate the delivery platforms into the learning institution's work flow and may provide contextual information, such as the user's role (e.g., student or faculty), and the course identifier to the engagement index calculation engine 1118.

The engagement index delivery platform 408 provides a user interface for presenting the engagement index to an institutional user computing device 1014b, such as an educator or administrator. Alternatively, the engagement index delivery platform 408 provides a user interface to present the engagement index to a student on the student computing device 1014a so the student can self-evaluate their progress and study habits and skills. In at least some embodiments, the engagement index delivery platform 408 also provides security and authentication functions to restrict access to student data to only authorized users.

FIG. 4 also illustrates a data processing system 410 for calculating the engagement index that includes the engagement index calculation engine 1118 and the engagement index parameters 1096 used to calculate the engagement index, such as weighting coefficients. Since the engagement index parameters 1096 may differ for different courses or areas of study, there are likely multiple sets of engagement index parameters 1096 needed for a single institution. In at least some embodiments, the engagement index calculation engine 1118 performs the operations described above in connection with FIGS. 1-3. Although FIG. 4 illustrates two systems, in at least some embodiments, the interface system 402 and the data processing system 410 are part of the same system or are distributed differently. For example, the interface system 402 and the data processing system 410 can be implemented by the server 1004 (shown in FIG. 9).

The systems illustrated in FIG. 4 are not limited to any particular hardware architecture or configuration. The systems may include one or more computing devices, storage devices, interfaces for connecting with other systems, and additional components. A computing device may include any suitable arrangement of components and programmable electrical circuits such as multipurpose microprocessor-based computer systems. The computing device may access computer-executable instructions from a computer-readable medium so that when the instructions are executed the computing system is transformed from a general-purpose computing apparatus to a specialized computing apparatus implementing one or more aspects of the present disclosure. Any suitable programming, scripting, or other type of language or combinations of languages may be used to implement the computer-executable instructions.

The engagement index delivery platform 408 provides a user interface that communicates engagement indexes and other information regarding engagement. In at least some embodiments, the engagement indexes may be aggregated across one or more dimensions, where the dimensions may include digital resources (or portions of a digital resource), courses, time periods, institutions, and geographic regions. In at least some embodiments, the engagement indexes are aggregated across a dimension by calculating one or more statistical values (e.g., average, mode, standard deviation, etc.) for a plurality of engagement indexes that relate to the dimension. The aggregated engagement indexes typically have the same factors, weighting coefficients, factor validation functions, and index validation functions. In alternative embodiments, however, one or more of the factors, weighting coefficients, factor validation functions, and index validation functions may vary between aggregated engagement indexes.

In an exemplary embodiment of aggregating engagement indexes, the engagement indexes for a specific digital resource are aggregated from the individual engagement indexes of multiple users to provide useful information to a provider of the digital resource. The aggregated engagement indexes can be used in different ways. For example, a low aggregated engagement index around a particular page, section, or book may suggest that changes are needed to the content. In another example, an individual student's engagement index is compared to one or more aggregated engagement indexes, such as an aggregation of the engagement index for all of the students in the class, to identify If the individual student's engagement index is significantly lower than the rest of the class, then the student may be at risk.

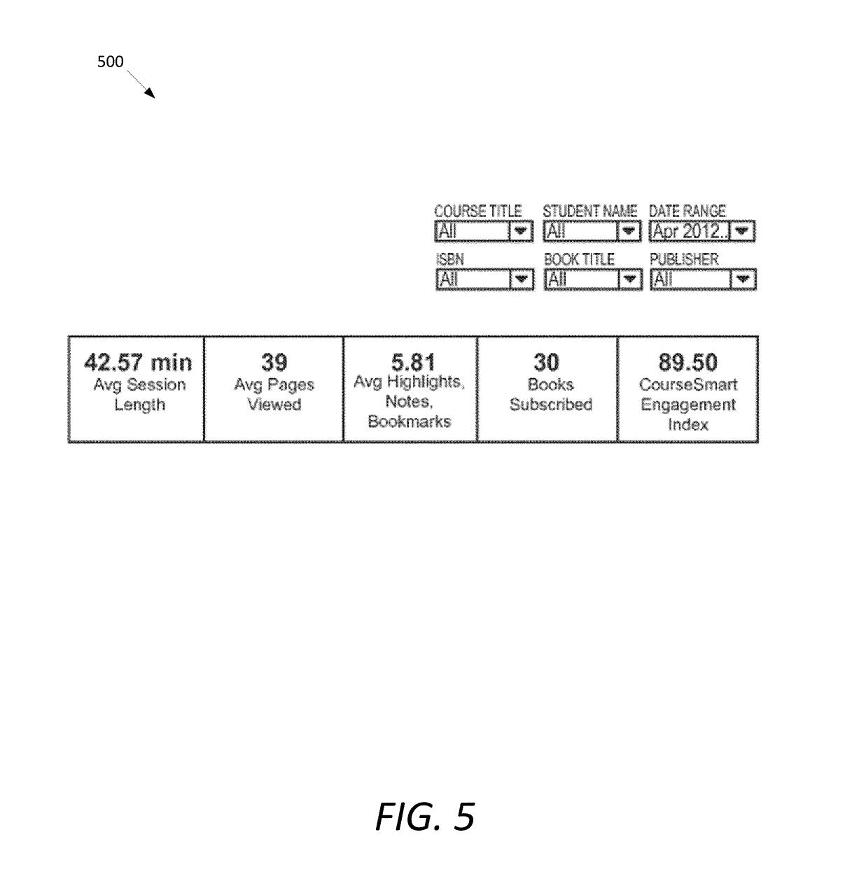

FIG. 5 illustrates an example user interface 500 generated by at least some embodiments of the user interface engine 1122. The user interface 500 displays an engagement score (89.50) for all students for a particular institution for a particular month. In addition to the engagement score, the user interface 500 displays the average session length (42.57 minutes), the average pages viewed (39), the average number of annotations (5.81) and the number of digital resources (30) included in the index. In FIG. 5 the average of the engagement indexes for multiple students for multiple digital resources over a one-month period is presented as the engagement index.

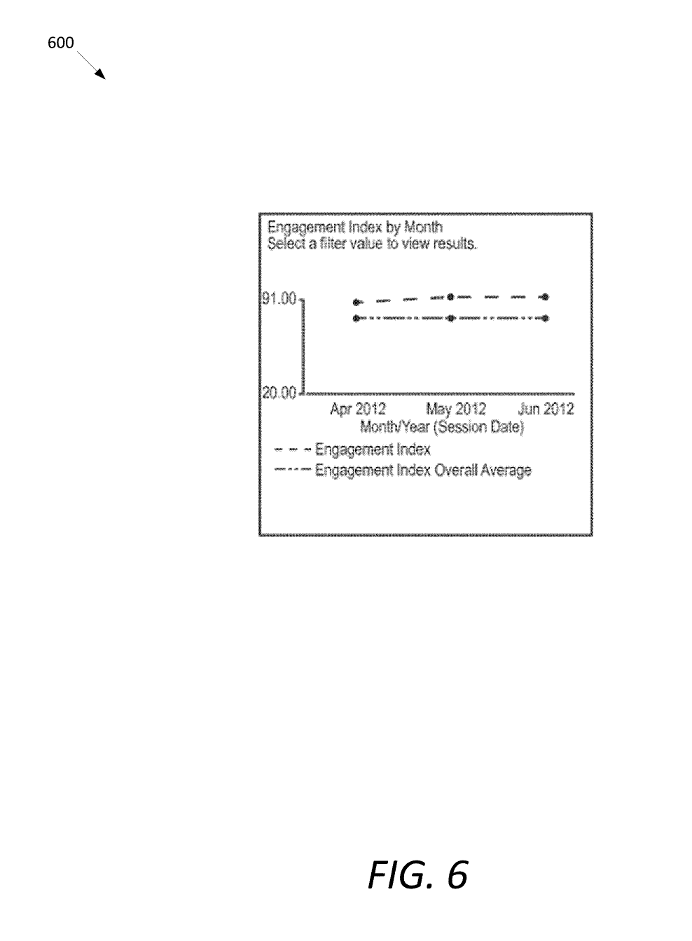

FIG. 6 illustrates an example user interface 600 generated by at least some embodiments of the user interface engine 1122. The user interface 600 compares the average of the engagement indexes for a particular student over a certain time period with the average of the engagement indexes for all of the students in the class or course over the same period of time. The engagement indexes may be related to a single digital resource or may be related to all digital resources for the class.

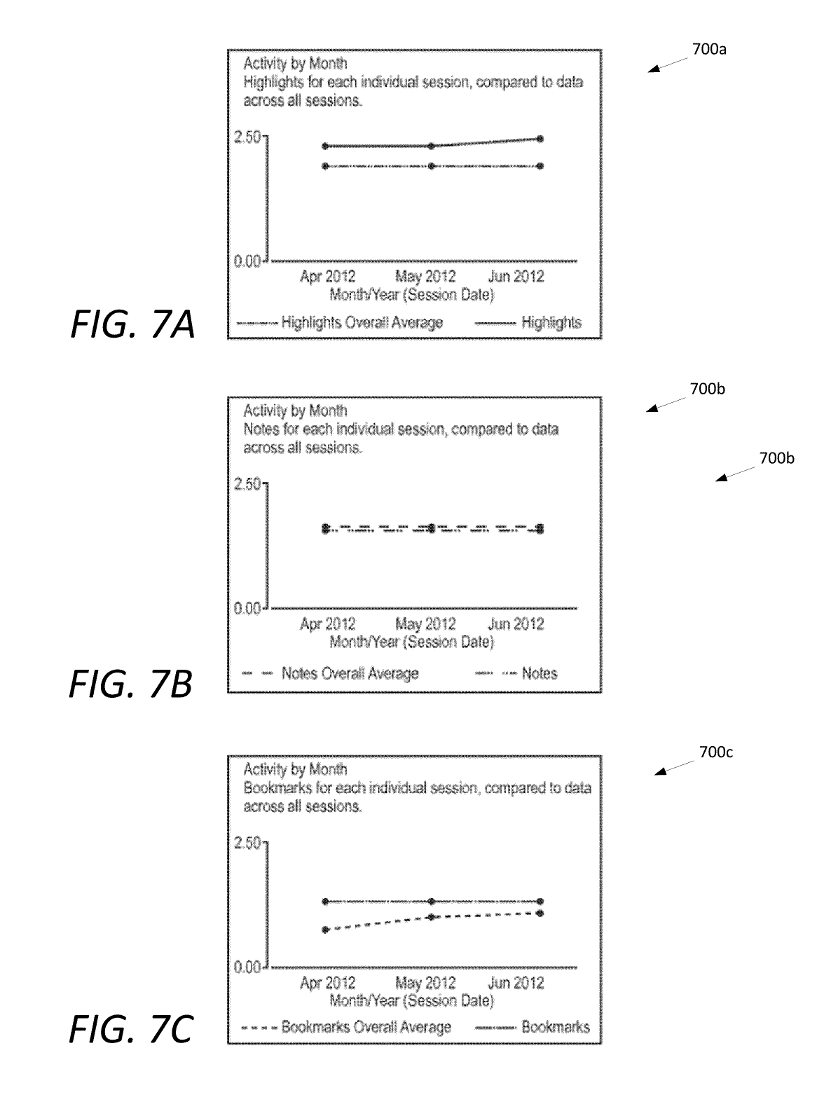

FIGS. 7A, 7B, and 7C illustrate example user interfaces 700a, 700b, and 700c generated by at least some embodiments of the user interface engine 1122. The user interfaces 700a, 700b, and 700c include validated annotation factor values used in the engagement indexes of FIG. 6. The user interfaces 700a, 700b, and 700c compare the average number of a particular type of annotations for a particular student over a certain time period with the average of that type of annotation for all of the students in the class over the same time period. The user interface 700a includes a comparison of the number of highlights. The user interface 700b includes a comparison of the number of notes. The user interface 700c includes a comparison of the number of bookmarks. Although shown separately in the figures, the comparisons are combined into a single user interface in alternative embodiments. Additionally, the values illustrated in the user interfaces 700a, 700b, and 700c are related to a single digital resource, although alternative embodiments might present values related to all digital resources for a class. These user interfaces can be used to help identify the specific activity or activities where a particular student differs from the rest of the class.

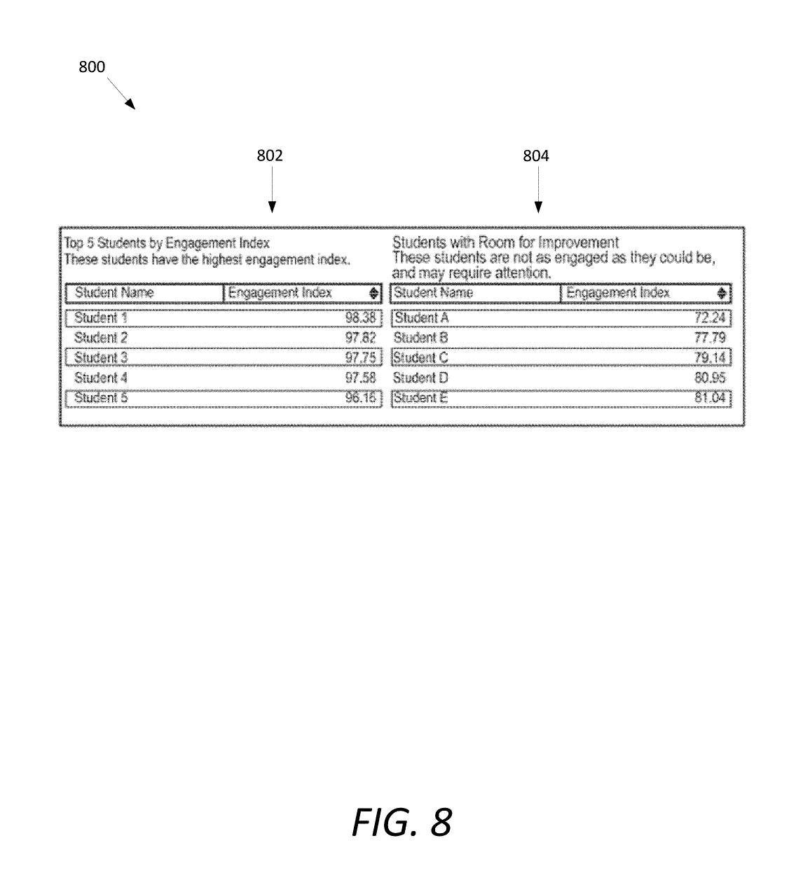

FIG. 8 illustrates an example user interface 800 generated by at least some embodiments of the user interface engine 1122. The user interface 800 includes a highest engagement index list 802 and a lowest engagement index list 804. The highest engagement index list 802 displays the names and engagement index values for students with the highest engagement index values. The lowest engagement index list 804 displays the names and engagement index values for students with the lowest engagement index values. The highest engagement index list 802 displays five students and the lowest engagement index list 804 displays five students. Alternatively, the highest engagement index list 802 and the lowest engagement index list 804 display more or fewer than five students. The students displayed in the highest engagement index list 802 and the lowest engagement index list 804 can be selected from a single course, multiple courses, a single institution, or multiple institutions. In at least some other embodiments, the students displayed in the highest engagement index list 802 and the lowest engagement index list 804 are selected from a different group. The highest engagement index list 802 can be used to identify students who are highly-engaged with the digital resource for positive reinforcement. Conversely, the lowest engagement index list 804 can be used to identify students who may need some additional help.

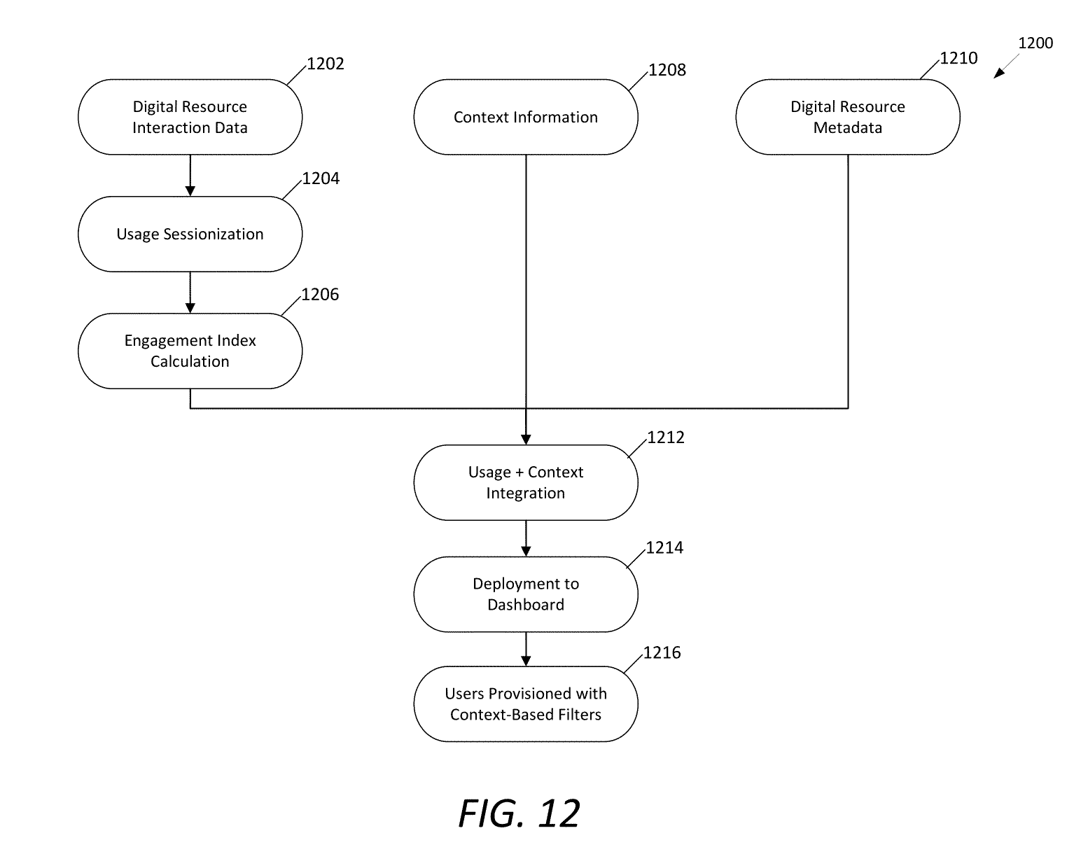

FIG. 12 illustrates an exemplary method 1200 for operating at least some embodiments of the platform 1002. In this example, the method 1200 includes operations 1202, 1204, 1206, 1208, 1210, 1212, 1214, and 1216. In some embodiments, the method includes operations that are performed by a processor (such as the processing device 1020, shown in FIG. 10).

The method begins at operation 1202 where the system collects the digital resource interaction data 1092. At operation 1204, the system divides the usage events into sessions. At operation 1206, the system calculates the engagement index.

Operation 1208 collects context information in which the digital resource interaction data 1092 is collected. Context information includes information that associates the digital resource interaction data 1092 with information identifying the environment or circumstances in which the digital resource interaction data was collected. Examples of context information include the identity or characteristics of a particular student, class, instructor, or institution. At operation 1210, dimensional metadata is collected. The dimensional metadata provides information about the digital resource. Examples of dimensional metadata include identifying information (e.g., identification number, title, subject matter, publisher, etc.) or other information about the digital resource.

At operation 1212, the digital resource interaction data 1092 and context information are associated with one another. At operation 1214, the associated information is deployed to a dashboard. In at least some embodiments, the dashboard is generated by the user interface engine 1122. At operation 1216, the user interface engine 1122 provides context-based filters to the user. In at least some embodiments, the context-based filters allow the user to display only results that match the filter. Examples of the context-based filters include filters that select results from a specific course, instructor, or institution.

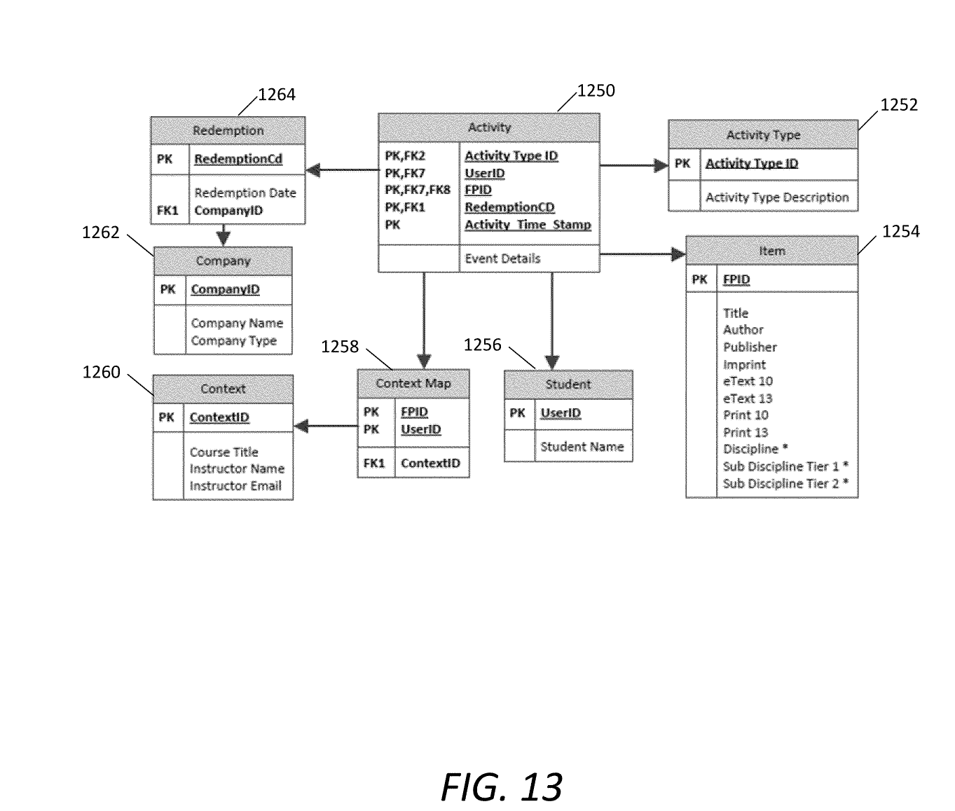

FIG. 13 illustrates an example format of the digital resource interaction data 1092. In this example, the digital resource interaction data 1092 is contained in a plurality of data structures in the form of tables utilizing primary keys (PK). Primary keys are used to map data between tables and to user interfaces. In this example, the tables of the digital resource interaction data 1092 are organized in either a star or snowflake schema, having a central fact table and a plurality of dimension tables. Other embodiments include other schemas, other types of data structures, and other methods of linking data structures.

The digital resource interaction data 1092 includes an activity table 1250, an activity type table 1252, an item table 1254, a student table 1256, a context map table 1258, a context table 1260, a company table 1262, and a redemption table 1264. Additional tables are included in other embodiments as needed. Further, some embodiments include different table structures. For example, the data from multiple tables can be merged into a single table or the data from a single table can be separated into multiple tables.

The activity table 1250 is a fact table in a star schema organization. The activity table 1250 includes a record for each recorded activity. The records in the activity table 1250 reference the activity type table 1252, the student table 1256, the item table 1254, and the redemption table 1264. Additionally, the activity table 1250 includes fields to record the activity time stamp and event details. Examples of the event details include the time spent viewing a page and the text added in an annotation. Other examples are possible as well.

The activity type table 1252 includes records that represent the different types of digital resource interaction activities (e.g., page view, highlight, note, bookmark, etc.) that are recorded by the system. The activity table includes an activity type ID field that is used as a primary key and an activity type description field that describes the activity.

The item table 1254 includes records that represent the digital resources that the users may interact with. The item table 1254 can include an FPID that is used as a primary key. The item table 1254 also includes one or more additional filed such as Title, Author, Publisher, Imprint, eText10, eText13, Print10, Print13, Discipline, Sub Discipline Tier 1, and Sub Discipline Tier 2. The Publisher and Imprint fields stores data identifying the publisher and division of the publisher, respectively, of the digital resource.

The eText10 field stores the ten digit International Standard Book Number (ISBN) of the digital resource. The eText13 field stores the thirteen digit ISBN European Article Number of the digital resource. Similarly, the Print10 field stores the ten digit International Standard Book Number (ISBN) of print edition corresponding to the digital resource. The Print13 field stores the thirteen digit ISBN or European Article Number of the print edition corresponding to the digital resource.

The Discipline, Sub-Discipline Tier 1, and Sub-Discipline Tier 2 are fields that store information used to classify the digital resources in a hierarchical manner by subject matter. As an example, a particular digital resource may be assigned a Discipline of chemistry, a Sub-Discipline tier 1 of bio-chemistry, and a Sub-discipline tier 2 of organic bio-chemistry. In at least some other embodiments, the subject matter of the digital resource is classified differently. For example, cross-discipline digital resources can be assigned a sub-Discipline Tier 2 that does not have a hierarchical relationship with the assigned Discipline. As an example, a particular digital resources may be assigned a Discipline of chemistry, a Sub-Discipline Tier 1 of bio-chemistry, and a Sub-Discipline Tier 2 of Biology. One or more of the Discipline, Sub-Discipline Tier 1, and Sub-Discipline Tier 2 fields can be assigned based on the Book Industry Standards and Communication (BISAC) codes. The Discipline, Sub-Discipline Tier 1, or Sub-Discipline Tier 2 fields can be used as a factor in calculating the engagement index or adjusting the parameters of the engagement index. The Discipline, Sub-Discipline Tier 1, or Sub-Discipline Tier 2 fields also can be used in the aggregation of engagement indexes.

The student table 1256 includes records that identifies the student users of the system. In at least some embodiments, the student table 1256 stores a user ID that is unique to each particular student. Additionally, in at least some embodiments, the student table 1256 also stores the name of the user, contact information for the user, or other information about the user. This additional information can facilitate follow-up contact by an instructor.

The context map table 1258 includes records that associate a user and a digital resource with a particular context. For example, the context can be a particular course at a particular institution. The records in the context map table 1258 are uniquely identified by a combination of the user and the digital resources and are mapped to a particular context. The context record also can include a course title, instructor name, and instructor e-mail address. Additionally, the context record may include one or more fields to uniquely identify the course by information such as the academic term, a unique section, or course identifier. This additional information can be useful when a student takes a course more than one time.

The redemption table 1264 includes records that identify how the user received access to the digital resources. For example, a company acquires and provides redemption codes to particular users. The redemption table 1264 records the redemption code and the associated company for a particular digital resource. The company table 1262 also can include records that represent entities that utilize digital resources. Learning institutions such as particular universities or high schools are examples of such entities.

This example structure of the digital resource interaction data 1092 illustrated in FIG. 13 is an example of one possible structure. Various other embodiments utilize other data structures and contain more or fewer data tables and data fields.

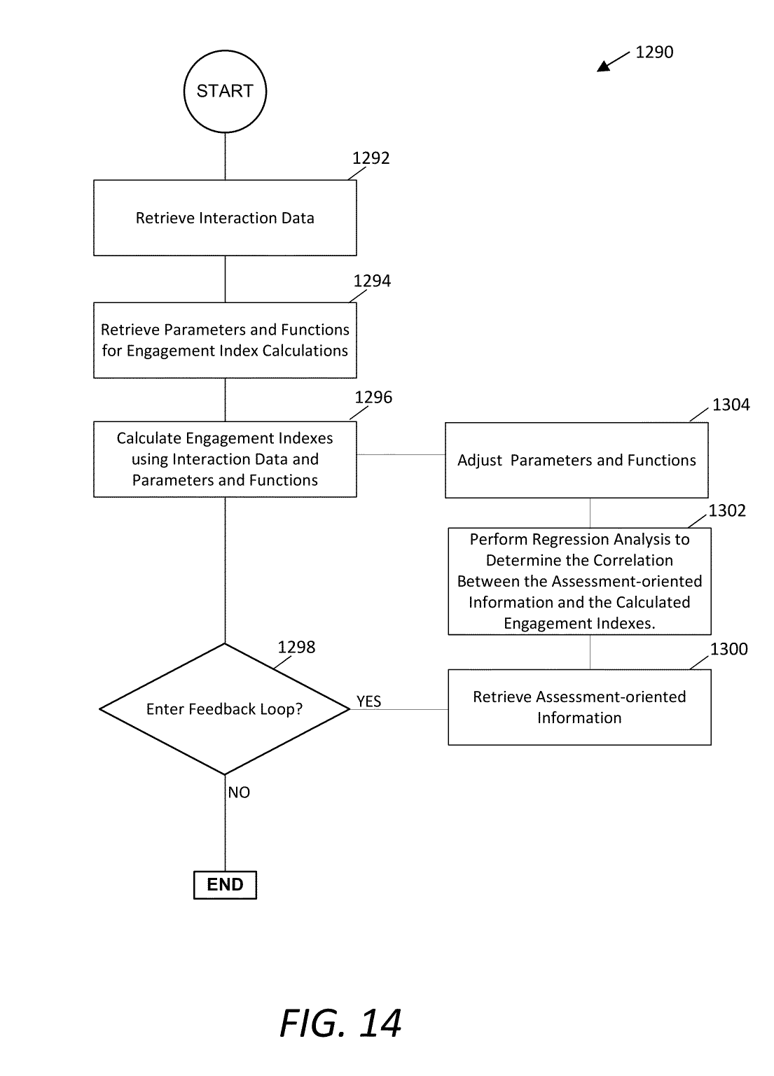

FIG. 14 illustrates an exemplary method 1290 for operating at least some embodiments of the engagement index parameter adjustment engine 1120 to adjust the parameters that are used to determine an engagement index. In this example, the method 1290 includes operations 1292, 1294, 1296, 1298, 1300, 1302, and 1304. The method includes operations that are performed by a processor (such as the processing device 1020, shown in FIG. 10).

At operation 1292, the digital resource interaction data 1092 is retrieved. In at least some embodiments, the digital resource interaction data 1092 is retrieved by querying the activity table 1250 (shown in FIG. 13).

At operation 1294, one or more parameters (e.g., weighting coefficients (a, b, c, . . . z) and threshold values) and functions (e.g., factor validation functions (ƒ_{1, 2, . . . n}) and index validation functions (ƒ₀)) for the engagement index calculations are retrieved . At operation 1296, the engagement indexes, EI, are calculated using the digital resource interaction data 1092 retrieved in operation 1292 and one or more of the parameters and functions retrieved in operation 1294.

At operation 1298, it is determined whether to enter a feedback loop. In at least some embodiments, the feedback loop is entered on occasions specified by an administrator or instructor. Alternatively, the feedback loop is entered on regular intervals (e.g., monthly, quarterly, or at the end of a semester) or upon the occurrence of a specific event (e.g., the entry of assessment oriented information such as quiz or exam results). Other embodiments are possible as well.

If the feedback loop is not entered at operation 1300, the method 1290 ends. If the feedback loop is entered at operation 1298, the method 1290 continues to operation 1300 where assessment-oriented information is retrieved from files or tables in the database 1006. The assessment-oriented information can be retrieved for a particular time period, user, instructor, subject matter, or course to tailor the parameter adjustment to a specific purpose.

At operation 1302, regression analysis is performed to determine the correlation between the assessment-oriented information and the calculated engagement indexes. Operation 1302 calculates a numerical value that represents the relationship between the assessment-oriented information and the calculated engagement indexes. The regression analysis is performed using linear regression or ordinary least squares regression, although other methods of performing the regression analysis can be used.

At operation 1304, the parameters and/or functions are adjusted to improve the correlation of the engagement indexes to the assessment-oriented information. The engagement index parameter adjustment engine 1120 adjusts one or more of the weighting coefficients used in calculating the engagement indexes. The weighting coefficients can be adjusted based on regression analysis of the various factors (e.g., session page views, session duration, session notes made, highlights made, and bookmarks made) individually. For example, the regression analysis identifies the factors that independently are the most closely correlated with the assessment-oriented information. The factors found to be the most highly correlated to the assessment-oriented information are weighted more heavily in the engagement index.

In at least some embodiments, the adjusted parameters and functions are stored in the database 1006. The parameters and functions can be adjusted globally such that they are used in all future engagement index calculations.

The adjusted parameters and functions can be used for specific purposes such as calculating an engagement index for a particular user, course, subject matter, instructor, or institution. For example, the parameters and functions used for calculating the engagement index for art history textbooks are adjusted differently than for mechanical engineering textbooks. Multiple sets of parameters and functions can be stored in the database 1006 and the sets are independently adjusted in the feedback loop.

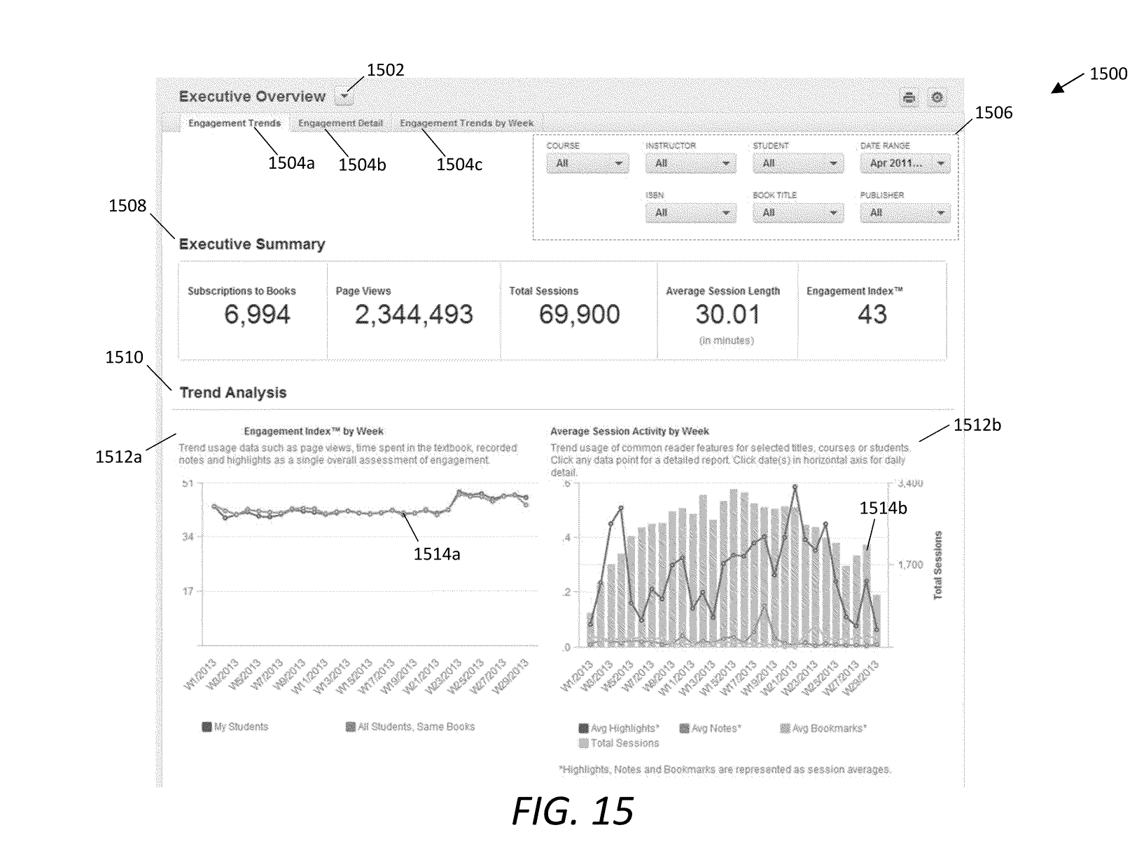

FIG. 15 illustrates an example user interface 1500 generated by at least some embodiments of the user interface engine 1122. The user interface 1500 displays a dashboard containing overview information. In at least some embodiments, the user interface 1500 includes a role selector 1502, panel selectors 1504a, 1504b, and 1504c, filter box 1506, executive summary 1508, and trend analysis section 1510, including chart 1512a and 1512b.

The role selector 1502 operates to allow a user to select a role. Example roles include executive (e.g., a dean or provost) and faculty (e.g., an instructor). At least some other embodiments include more, fewer, or different roles. The content of the user interface 1500 can change based on the role selected. Access to at least some of the roles can be limited to certain users.

The panel selectors 1504a, 1504b, and 1504c are associated with a panel and allow a user to select between different panels of data provided by the user interface 1500. Example panels include engagement trends (shown in FIG. 15), engagement detail, and engagement trends by week. At least some other embodiments include more, fewer, or different panels and associated panel selectors.

The filter box 1506 includes various filters that a user may select to apply to the data. Example filters include course, instructor, student, date range, ISBN, book title, and publisher. In at least some embodiments, when a filter is applied the user interface 1500 is updated to include results that match the filter. Alternative embodiments can include more, fewer, or different filters.

The executive summary 1508 displays various information about the engagement indexes and the content of the database 1006. In at least some embodiments, the executive summary 1508 displays summary-level information. Examples of summary-level information include the number of subscriptions to books, the number of pages viewed, the total number of sessions, the average session length, and the average engagement index. In at least some embodiments, the information displayed in the executive summary is updated when the filters in the filter box 1506 are changed. At least some other embodiments include more, fewer, or different information.

The trend analysis section 1510 displays charts that display how properties of the data stored in the database have changed over time. Examples of the charts include charts 1512a and 1512b. At least some other embodiments include more, fewer, or different charts.

The example chart 1512a displays the engagement index by week, and each data point (displayed as a circle) represents the average engagement index during a particular week. The example chart 1512a includes two trend lines. The first trend line shows the average engagement index for all students of a particular faculty member or other intuitional user during a particular week. The second trend line shows the average engagement index for all students using the same digital resource during that same week.

The example chart 1512b displays the average session activity by week. In at least some embodiments, the total number of sessions are displayed for each week (shown as bar graphs). Additionally, the total number of various activities per sessions are displayed for each week. The example chart 1512b includes trend lines for the average numbers of highlights, notes, and bookmarks per session. Alternative embodiments can display more, fewer, or different trend lines.

Additionally, the individual data points or other items displayed in the charts 1512a and 1512b can include or be embedded with selectable controls that a user can actuate (e.g., click on) to drill down and view more information associated with that data point or other item. For example, the user interface may include selectable controls associated with data points 1514a and 1514b so that a user can click on one of those data points to view additional information.

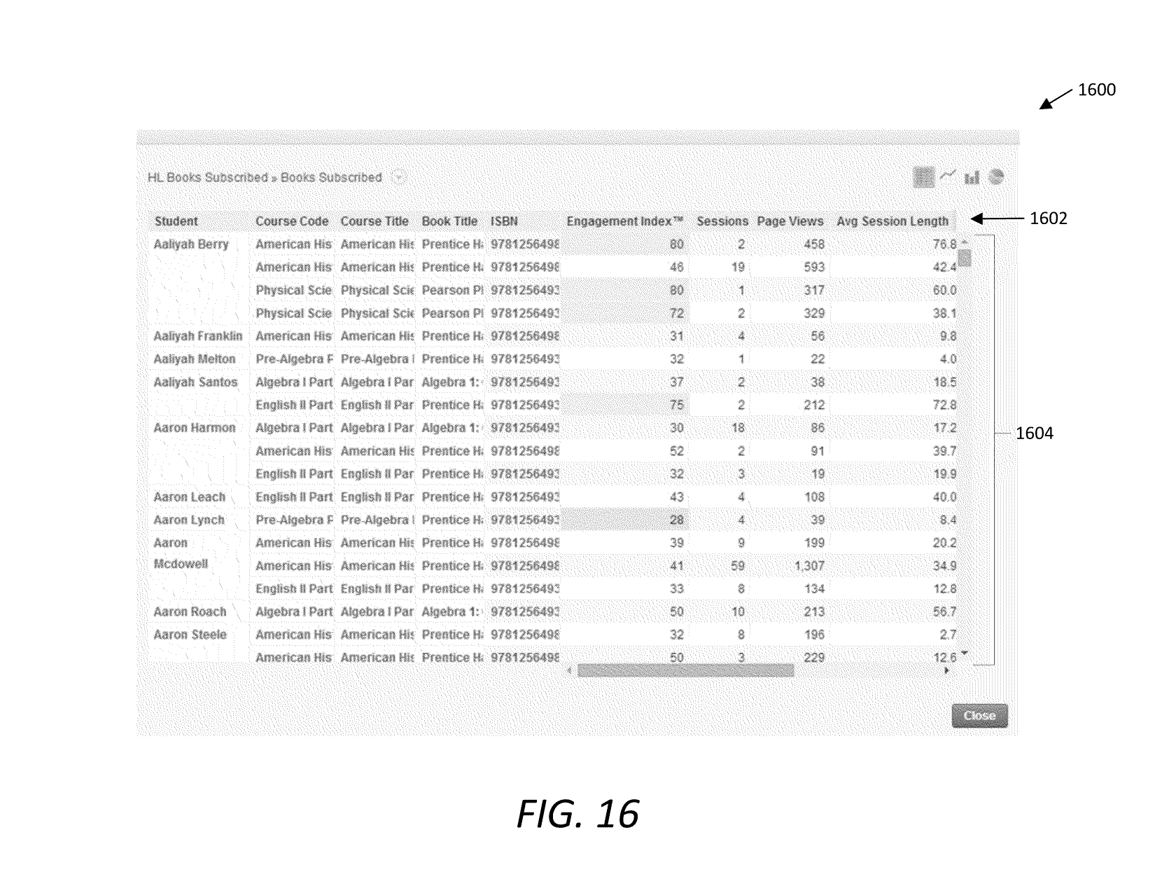

FIG. 16 illustrates an example user interface 1600 generated by at least some embodiments of the user interface engine 1122. The user interface 1600 displays a chart of students and their engagement indexes for various courses and includes a data header 1602 and a data section 1604.

The user interface sorts the data in the data section when the user clicks on a portion of the data header 1602. For example, if the user clicks on the Engagement Index header, the data section is sorted from highest engagement index to lowest engagement. If the user click on the Engagement Index header again, the order is reversed and the values in the data section are sorted from lowest engagement index to highest engagement index.

The data section 1604 displays rows of data, each representing the engagement of a particular student with a digital resource for a particular course. Each row displays a student name, course code, course title, book title, ISBN number, engagement index, session count, page views count, and average session length, although more, fewer, or different information can be displayed in each row.

The user interface 1600 displays the background of the engagement index in a color to indicate whether the engagement index is high, low, or in the middle. For example, the background of the engagement index is displayed in green to indicate the score is high or is displayed in red to indicate the score is low. Other embodiments are possible as well. For example, colored fonts can be used instead of or in addition to colored backgrounds, or no coloring can be used at all. Additionally, indicia other than color can be used to highlight data.

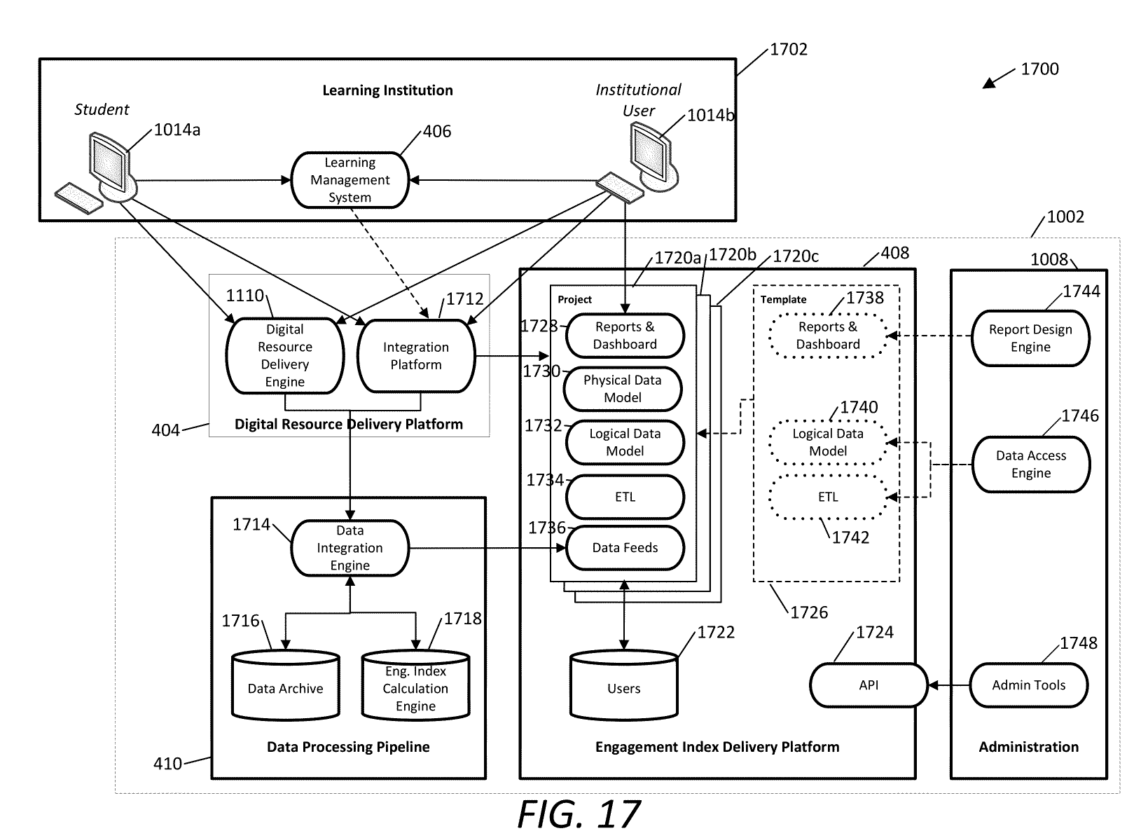

FIG. 17 illustrates another exemplary embodiment of a digital resource delivery system 1700. The digital resource delivery system 1700 includes a learning institution 1702 and an embodiment of the platform 1002 for analyzing engagement with digital resources. The platform 1002 includes the digital resource delivery platform 404, the data processing system 410, the engagement index delivery platform 408, and the administration computing device 1008.

The learning institution 1702 includes the student computing device 1014a, the institutional user computing device 1014b, and the learning management system 406. In the embodiment illustrated in FIG. 17, the learning management system 406 is separate from the platform 1002. However, in at least some other embodiments, the learning management system 406 is part of the platform 1002.

The digital resource delivery platform 404 includes the digital resource delivery engine 1110, and an integration platform 1712. The integration platform provides institution-specific, course-specific, or instructor-specific content for the digital resource that is delivered by the digital resource delivery engine 1110. In at least some embodiments, the digital resource delivery platform 404 is accessed by the student computing device 1014a, the institutional user computing device 1014b, or the learning management system 406.

The data processing system 410 operates to process access and interaction information related to a digital resource. The data processing system 410 includes a data integration engine 1714, data archive 1716, and engagement index calculation engine 1718.

The data integration engine 1714 operates to store activity and interaction information related to a digital resource in the data archive 1716 and to transmit activity and interaction information to the engagement index calculation engine 1718. Additionally, the data integration engine 1714 receives analytic information (such as engagement index scores) from the engagement index calculation engine 1718 and transmits that analytic information to the engagement index delivery platform 408. The data integration engine 1714 integrates the analytic information with additional information stored in the database 1006 (e.g., information that relates to the digital resource, institution, user, etc.).

The engagement index delivery platform 408 operates to provide a user interface that displays the engagement index. The engagement index delivery platform 408 includes one or more projects 1720a, 1720b, and 1720c, a user database 1722, a template 1726, and an application programming interface (API) 1724.

The projects 1720a, 1720b, and 1720c are logical data structures and include the report format information and information relevant to computing and displaying the engagement index. Examples of information in the projects include reports & dashboards 1728, a physical data model 1730, a logical data model 1732, extract/transfer/load (ETL) functions 1734, and data feeds 1736. The reports & dashboards 1728 operate to define the user interface for displaying the engagement index information. The physical data model 1730 operates to represent the location and format of the data being displayed. The logical data model 1732 operates to represent the logical organization of the data. The ETL functions 1734 operate to extract, transform, and load data received from other systems. The ETL functions convert the data received in the data feeds 1736 into the appropriate format for the project. The data feeds 1736 operate to receive data from one or more systems (e.g., the data processing system 410). A project corresponds to a single institution. Alternatively, a project can correspond to and is shared by more than one institution.

The template 1726 operates to define a project. In at least some embodiments, common elements of multiple projects are defined in a template. For example, in some embodiments, the template 1726 includes a reports & dashboard template 1738, logical data model template 1740, and ETL functions template 1742. A new project can be deployed using the administration computing device 1008 by copying some or all of the elements of a template into a new project.

The user database 1722 includes records representing users of the engagement index delivery platform 408. In some embodiments, the user database 1722 includes permission levels for the users that define the projects and the information within a project that the user may access. The user database 1722 comprises one or more database tables or files.

The API 1724 operates to provide programmatic access to the engagement index delivery platform 408. The API 1724 is used to provide access to the engagement index delivery platform 408 through different interfaces and to provide new capabilities. For example, in at least some embodiments, the API 1724 is used to provide access to the engagement index delivery platform 408 through a smart phone. In at least some embodiments, the API 1724 is also used to provide administrative tools to manage user access. The API 1724 can be used for other purposes.

The administration computing device 1008 includes a report design engine 1744, a data access engine 1746, and admin tools 1748. The report design engine 1744 operates to design the reports and dashboards that are displayed in the user interfaces of the engagement index delivery platform 408. The data access engine 1746 operates to provide access to the data in the engagement index delivery platform 408 (e.g., for mass import or export of records). The admin tools 1748 operate to provide access to the engagement index delivery platform 408 for administrative purposes. Examples of administrative purposes include administering user accounts and access permissions, modifying data records, reviewing data logs, backing up data, etc. The admin tools 1748 can serve other purposes as well.

The digital resource delivery system 1700 can be implemented using multiple computing devices located in one or more geographical locations. Alternatively, the digital resource delivery system 1700 can be implemented using a single computing device. Other embodiments are possible as well. Additionally, the digital resource delivery system 1700 can include more, fewer, or different components than illustrated herein.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A user engagement assessment system for assessing engagement with digital resources, the engagement system comprising:
a memory containing interaction data between users and digital resources;
first circuitry configured to generate a graphical user interface including engagement index information based on the interaction data, the graphical user interface having an input region and a display region, the display region displaying an engagement index value based on the interaction data;
second circuitry configured to receive input information corresponding to a filter selection by an operator in the input region; and
third circuitry configured to update the display portion of the graphical user interface to display an updated average engagement index value based on the interaction data that matches the filter selection.

2. A user engagement assessment system for assessing engagement with digital resources, the engagement system comprising:
a memory containing interaction data between users and digital resources;
first circuitry configured to generate a graphical user interface having an input region and a display region, the display region displaying a chart including a plurality of data points that represent the average engagement index for users during a particular time period;
second circuitry configured to receive input information corresponding to an operator input in the input portion, wherein the input information identifies a data point from the plurality of data points; and
third circuitry configured to update the display portion of the graphical user interface based on the input information to display a plurality of the engagement index values used to compute the average engagement index at the identified data point and a plurality of factor values used in computing the plurality of engagement index values.

3. The engagement system of claim 2, wherein the input region and the display region overlap.

4. The engagement system of claim 2, wherein the graphical user interface comprises a web page.

5. The engagement system of claim 2, wherein the second circuitry is configured to receive input information from a computing device over a network.

6. The engagement system of claim 2, wherein the interaction data comprises data relating to interactions between users and digital resources, wherein the interactions represent page views, notes made, highlights made, and bookmarks.

7. The engagement system of claim 2, wherein the digital resource is an eTextbook.

8. A method of generating a graphical user interface for use in assessing engagement with digital resources, the method comprising:
calculating, with a computing device, a plurality of engagement indexes based on interaction data, wherein the interaction data represents interactions between users and digital resources;
generating a graphical user interface including an input portion and a display portion, the display portion displaying a chart including a plurality of data points that represent the average engagement index for users during a particular time period;
receiving input information corresponding to an operator input in the input portion, wherein the input information identifies a data point from the plurality of data points; and
updating the display portion of the graphical user interface based on the input information to display a plurality of the engagement index values used to compute the average engagement index at the identified data point and a plurality of factor values used in computing the plurality of engagement index values.

9. The method of claim 8, wherein the interactions represent page views, notes made, highlights made, and bookmarks.

10. The method of claim 8, further comprising dividing the interaction data into a plurality of sessions representing blocks of time spent interacting with a digital resource by a user.

11. The method of claim 8, wherein the digital resource is an electronic book.

12. The method of claim 8, wherein the digital resource is an eTextbook.

13. The method of claim 8, wherein the digital resource is a web site.

14. The method of claim 8, further comprising transmitting the graphical user interface over the network.

15. The method of claim 8, further comprising displaying the graphical user interface on a display device.

16. The method of claim 8, wherein the display portion displays an average engagement index for a particular digital resource.

17. The method of claim 8, wherein the plurality of data points represent the average engagement indexes for a plurality of portions of a particular digital resource.

18. A method of generating a graphical user interface for use in assessing student engagement with eTextbooks, the method comprising:
receiving interaction data comprising data relating to interactions between student and eTextbooks, wherein the interactions represent page views, notes made, highlights made, and bookmarks;
dividing the interaction data into a plurality of sessions representing a block of time spent interacting with an eTextbook by a student;
calculating, with a computing device, engagement indexes for a plurality of the sessions, wherein the engagement index is a numerical value that represents a particular student's engagement with a particular eTextbook during a particular session, wherein calculating the engagement index comprises:
calculating a session duration factor for the particular session based on the length of time the particular student spent interacting with the particular eTextbook during the particular session;
calculating a page views factor for the particular session based on the interactions representing page views for the particular session;
calculating a notes made factor for the particular session based on the interactions representing notes made for the particular session;
calculating a highlights made factor for the particular session based on the interactions representing highlights made for the particular session;
calculating a bookmarks factor for the particular session based on the interactions representing bookmarks for the particular session;
calculating a score associated with a weighted combination of at least the session duration factor, the page views factor, the notes made factor, the highlights made factor, and the bookmarks factor; and
determining the engagement index by adjusting the score to ensure the score is less than an upper bound and greater than a lower bound;
generating a graphical user interface comprising:
a first display portion that displays an average engagement index for students at a particular institution over a particular time period;
a second display portion that displays a chart including a plurality of data points that represent the average engagement index for students at the particular institution during a portion of the particular time period; and
an input portion that overlays the second display portion;
receiving input information corresponding to an operator input in the input portion, wherein the input information identifies a data point from the plurality of data points; and
updating the graphical user interface based on the input information to display a plurality of the engagement index values used to compute the average engagement index at the identified data point and at least one of the session duration factor, the page views factor, the notes made factor, the highlights factor, and the bookmarks factor for at least one of the plurality of engagement index values.

19. The method of claim 18, further comprising displaying the graphical user interface on a display device.

20. The method of claim 18, further comprising transmitting the graphical user interface over a network.
